(19) United States
(12) Patent Application Publication
(10) Pub. No.: US 2004/0208395 A1
(43) Pub. Date: Oct. 21, 2004

(54) Image processing method, image processing apparatus, and image processing program

(75) Inventor: Shoichi Nomura, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA PHOTO IMAGING, INC.

(21) Appl. No.: 10/823,571

(22) Filed: Apr. 14, 2004

(30) Foreign Application Priority Data
Apr. 18, 2003 (JP) JP2003-114339

(51) Int. Cl. G06K 9/00; G06K 9/40; H04N 5/253

(52) U.S. Cl. 382/275; 382/300; 348/96

(57) ABSTRACT

An image processing method has the steps of dividing the image information into data of sound pixels and data of defective pixels, calculating an interpolation signal value of each of the defective pixels on the basis of data of a plurality of sound pixels existing in the surrounding area, calculating a provisional correction value on the basis of the signal value and the interpolation signal value of each of the defective pixels, and calculating a modified pixel correction value of each of the defective pixels on the basis of the provisional correction value of each of the defective pixels and the provisional correction value of neighboring defective pixels, and correcting the data of each of the defective pixels by the use of the modified pixel correction value.

### BACKGROUND OF THE INVENTION

This invention relates to an image processing method, an image processing apparatus, and an image processing program.

In recent years, it prevails a system in which an image is photographed by means of a silver halide photographic film, and the image, having been subjected to a development process, is then read by an image reading apparatus such as a film scanner, to be acquired as image data, which are utilized in various ways. Because a silver halide film has a very large information volume, the image reading apparatus requires a very high resolution for reading microscopic signals with certainty.

On the other hand, for the purpose of making the handling easy, a photographic film is composed of an image recording layer including a binder mainly of gelatine coated on a film base made of TAC (triacetyl cellulose), PET (polyethylene terephthalate), or the like, is easy to catch dust and dirt, and is easy to be damaged because both the image recording layer and film base have a low hardness.

For this reason, the handling of a photographic film has to be done carefully, and requires considerable working hours. Further, as described above, because image information acquired by means of an image reading apparatus having a very high resolution has microscopic damages and dust recorded, the restoration of the image information has heretofore required a great deal of labor.

In view of the above-mentioned situation, several countermeasures have been investigated, and proposed. One of the main countermeasures is a method using infrared rays in which the feature of a photographic film that image information is formed of dye images is utilized (for example, refer to the patent literature 1).

The basic idea of this method is based on the following way of thinking. As described above, image information is formed of dye images, and the dyes absorb visible electromagnetic waves of a specified wavelength region but hardly absorb infrared rays of long wavelengths owing to their natures. On the other hand, flaws and dust are colorless as themselves in most cases, but they have a nature to scatter light strongly, and if these are put on the way of an image forming system, light scattering is produced, and it can be said that the signal strength to be obtained as image information is reduced by the amount of decrement due to the scattering. As regards this influence of flaws and dust, because it appears approximately equally irrespective of the difference in the wavelength, whether the irradiation is made by visible light or infrared rays, it is such that, when one observes an infrared image, one can recognize the position and the influence of the flaws and dust.

Of course, as described in the patent literature 1, actually, because dyes, in particular cyan dyes, which form image information have some amount of infrared absorption, it is usual to carry out a processing for reducing the influence of these dyes prior to the observation of an infrared image in the same way as a method of color separation of a color film.

Further, there has been a method in which, through the detection of flaws and dust by means of an infrared image, an image is divided into sound pixels and abnormal pixels, and the abnormal pixels are substituted by an interpolation from a group of sound pixels in the nearest neighborhood (for example, refer to the patent literature 2). According to this method, because it is possible to fill up a flaw area by an interpolation from the surrounding area, flaws and dust can be erased from an image frame. However, according to this method, because data of an area regarded as abnormal pixels are acquired by an interpolation from image information of an area regarded as sound pixels, the processing is accompanied by a large side effect that the original image information volume is greatly reduced.

In order to cancel this point of problem, there has been a method in which the influence of flaws and dust given to an infrared image is detected, a correction of an amount equivalent to the influence is applied to the visible image, and further, if the above-mentioned influence is very large, the image data are processed by an interpolation method as described in the patent literature 2 (for example, refer to the patent literature 3). According to this method, even for pixels including a flaw and/or dust, in a place where the influence is comparatively slight, a processing for correcting the influence of a flaw and/or dust is carried out; therefore, the decrease of image information volume is less in comparison with a case where an interpolation method is used.

[Patent Literature 1]

The publication of the examined patent application H6-5914

[Patent Literature 2]

The publication of the unexamined patent application S63-129469

[Patent Literature 3]

Publication of the patent No. 2559970

[Problem to be Solved by the Invention]

However, according to the patent literature 3, because the degree of the influence given by flaws and dust is obtained mainly by the use of an infrared image, points of problem to be described below are produced.

The first point of problem is that, because a premise that the influence of flaws and dust appears in both a visible image and an infrared image with a definite correlation is made in the method of the patent literature 3, for example, in a case where an image recording layer is damaged to produce a slight loss of image information, in an infrared image, the lowering of signal strength due to the scattering of light is large, which results in the decreasing of the signal, but in a visible image, due to the loss of an image recording layer absorbing visible light, the signal strength is made higher in some cases. According to the method of the patent literature 3, in such a case, because a reverse correction, that is, to raise the signal strength of the visible image, is made, there has been a risk such that, on the contrary, the influence of flaws and dust is made larger.

The second point of problem is that, although it is supposed that the influence of flaws and dust appears with a definite correlation between a visible image and an infrared image, various kinds of aberration such as a spherical aberration in addition to a color aberration are produced by an actual optical lens. Further, because there is a wavelength dependence in the coating for reducing diffused reflection by the boundary surface of a lens and also in the scattering characteristic of a flaw itself on a film base, as regards a flaw on a base film, although there is a correlation of the influence of the flaw between a visible image and an infrared image, the correlation ratio is not always definite. For that reason, one should have some fear that an excessive correction or a deficient correction is produced in the correction for flaws and dust.

It is the first object of this invention to make it possible to satisfactorily carry out the removal of the influence of flaws and dust in visible image information so long as correction of aberration is sufficiently made for the visible image, even if some amount of residual aberration exists for the infrared image information. Further, it is the second object of this invention to suitably judge the influence of flaws given to a visible image, to obtain a satisfactory correction result for flaws on both the base surface and image recording layer of an image information acquisition source.

### SUMMARY OF THE INVENTION

The above mentioned object can be accomplished by an invention having any one of the following features.

(1) An image processing method in which image information is divided into data of sound pixels and data of defective pixels and a correction for the data of defective pixels is made on the basis of, at least, the data of surrounding sound pixels, characterized by the steps of

calculating an interpolation signal value of each of said defective pixels on the basis of data of a plurality of sound pixels existing in the surrounding area of each of said defective pixels in said image information, and calculating a provisional correction value for correcting data of each of said defective pixels on the basis of the signal value and said interpolation signal value of each of said defective pixels, and

calculating a modified pixel correction value of each of said defective pixels on the basis of said provisional correction value of each of said defective pixels and said provisional correction value of neighboring defective pixels existing in the neighborhood of each of said defective pixels, and correcting the data of each of said defective pixels by the use of the modified pixel correction value.

The term “a defective pixel” means a defective pixel caused by, for example, a flaw (including a damage) and/or dust. A defective area to be described later is an area where said defective pixels get together.

According to the invention set forth in (1), each of modified correction values is calculated on the basis of a provisional correction value of each of defective pixels and provisional correction values of its neighboring defective pixels in image information, and the pixel value of each of the defective pixels is corrected by the use of each of the modified correction values. Owing to this, even, for example, in a defective condition such that an image loss caused by a damage in the image recording layer of an image information acquisition source is produced, which makes the correction of signal strength based on the image information of the infrared region a reverse correction, or in a state that the influence of a residual aberration of an amount not to be neglected remains in the image information of the infrared region, a satisfactory result of image processing can be obtained, because data of defective pixels are corrected on the basis of the image information of the visible regions. Further, a high-accuracy removal of the influence of defects can be actualized by the correction of image information through the procedure that a provisional correction value is obtained for each of the defective pixels, and the error portion of the provisional correction value is removed as a noise by the modified pixel correction value.

(2) An image processing method as set forth in (1), characterized by the aforesaid image information being composed of bits of information concerning at least three kinds of color component, and by it that

in the aforesaid step of calculating the aforesaid modified pixel correction value, each of the aforesaid provisional correction values is calculated for each of said plural color components, and each of said modified pixel correction values for each of said plural color components is calculated from each of the provisional correction values for each of said plural color components.

According to the invention set forth in (2), because correction values are obtained by the use of plural color images, information volume to be used in calculating correction values is increased, and a removal of the influence of defects with a high effect of removal of the noise component of image information can be actualized.

(3) An image processing method in which image information is sorted into data of a sound area and data of a defective area and data of defective pixels belonging to said defective area are corrected, characterized by it that

a group of sound pixels existing within a first specified distance from the boundary of said defective area is defined as a peripheral area, and

in the correction of image data of a defective pixel in said defective area, a defective area characteristic value and a peripheral area characteristic value of said pixel are calculated on the basis of pixel values existing within a second specified distance from said defective pixel in said defective area and in said peripheral area respectively, a correction value to be used in the correction of the image data of said defective pixel is calculated on the basis of said characteristic values, and image data of pixels in said defective area are corrected through the correction of each of all the defective pixels by the use of the correction value concerned.

According to the invention set forth in (3), correction values are calculated from the defective area characteristic values and the peripheral area characteristic values of the image information itself, and image information of the visible region is corrected by the use of the correction values. Owing to this, for example, even for a defective condition such that an image loss caused by a damage in the image recording layer of an image information acquisition source is produced, which makes the correction of signal strength based on the image information of the infrared region a reverse correction, it is possible to effectively cope with the defective condition by a correction using image information of not the infrared region but the visible regions. Further, by the correction using the correction values calculated from the defective area characteristic values and the peripheral area characteristic values, even if the characteristics such as the aberrations and flare characteristics of the optical system used in the acquisition of the image information are unknown, a correction result which is neither excessive nor insufficient can be obtained.

(4) An image processing method in which image information is sorted into image data of a sound area and image data of a defective area and image data of defective pixels belonging to said defective area are corrected, characterized by it that

an area of sound pixels existing within a first specified distance from the boundary of said defective area is defined as a peripheral area, and

in the correction of the image data of a defective pixel in said defective area, first information as the result of application of a specified high-pass filter to the image data of pixels in the defective area located within a second specified distance from said defective pixel and second information as the result of application of a specified low-pass filter to the image data of pixels in said peripheral area located within a third specified distance from said defective pixel are calculated, and the image data of said defective pixel in said defective area are corrected through the substitution of it by the third information obtained by the addition operation of said first information and said second information.

According to the invention set forth in (4), the third information as the correction value is calculated through the addition of the first information based on the defective area in the image information itself and the second information based on its peripheral area, and the image information is corrected by the use of the third information. Owing to this, by the correction of the image data of pixels in a defective area caused by a damage of the image recording layer of the image information acquisition source, even if the characteristics such as the aberrations and flare characteristics of the optical system used in the acquisition of the image information are unknown, a correction result which is neither excessive nor insufficient can be obtained.

(5) An image processing method in which image information is sorted into image data of sound pixels and image data of defective pixels, and said image data of defective pixels are corrected on the basis of image data of surrounding sound pixels, characterized by it that

said image data of defective pixels are divided into a plurality of groups on the basis of their respective feature quantities,

provisional correction values for correcting the image data of their respective defective pixels in said image information are calculated,

on the basis of each of said provisional correction values of each of said defective pixels and said provisional correction values of neighboring defective pixels which belong to the same group as said defective pixels and exist in the neighborhood of each of said defective pixels, a modified pixel correction value for each of said defective pixels is calculated, and

the image data of each of said defective pixels are corrected by the use of said modified pixel correction value.

According to the invention set forth in (5), defective pixels are divided into a plurality of groups, modified pixel correction values are calculated on the basis of provisional correction values of each of said defective pixels and provisional correction values of each of its neighboring defective pixels belonging to the same group, and the image data of each of the defective pixels are corrected by the use of each of modified pixel correction values concerned. Owing to this, because the image data of the defective pixels caused by a damage in the image recording layer of an image information acquisition source are divided into a plurality of groups on the basis of their respective feature quantities, and their image data are corrected on the basis of their respective groups, a desirable correction result of a higher degree of freedom can be obtained. Further, even in a state that residual aberrations of an amount not to be neglected remain in the image information of the infrared region, image data of defective pixels are corrected on the basis of image information of the visible regions; therefore, a satisfactory image processing result can be obtained.

(6) An image processing method in which image information consisting of visible image information and infrared image information are sorted into image data of a sound area and image data of a defective area, and visible image information of defective pixels belonging to said defective area is corrected, characterized by it that

for each of said defective pixels within a specified distance from a target defective pixel to become the object of correction, a first pixel correction value is calculated on the basis of visible image information of pixels existing in said sound area, from which their total sum is obtained,

for each of said defective pixels within said specified distance, an infrared [signal variation value] difference data is calculated on the basis of the infrared image information, from which their total sum is obtained, and the proportion of the infrared [signal variation value] difference data corresponding to said target defective pixel to said total sum of the infrared [signal variation value] difference data is obtained, and further,

image data of said target defective pixel are corrected on the basis of the total sum of said first pixel correction values and said proportion.

According to the invention set forth in (6), the total sum of the influence given to image information by a defect caused by a flaw, dust, or the like and the relative degree of influence of the defect of each pixel are inferred from the visible image information and the infrared image information respectively; therefore, even in a case where there is a difference in image quality items such as the MTF and flare between the infrared image information and the visible image information, a satisfactory correction for image defects can be carried out.

Further, an image processing apparatus for actualizing an image processing method of the feature described in any one of (1) to (6), and an image processing program for making a computer actualize these image processing functions are also important features of this invention.

### BRIEF DESCRIPTION OF THE DRAWINGS

FIG. 1 is a block diagram showing an image processing system 10 of the embodiment of this invention;

FIG. 2 is a drawing showing the structure of a transmission original scanner 142;

FIG. 3 is a flow chart showing an image processing;

FIG. 4 is a flow chart showing a flaw/dust processing;

FIG. 5 is a drawing showing light absorption signals of their respective wavelength regions;

FIG. 6 is a flow chart showing a detection processing of a flaw/dust candidate area;

FIG. 7 is a flow chart showing a determination processing of a flaw/dust candidate area;

FIG. 8 is a flow chart showing a first flaw/dust correction processing;

FIG. 9 is a drawing showing a flaw/dust area and its peripheral area;

FIG. 10 is a flow chart showing a second flaw/dust correction processing;

FIG. 11 is a drawing showing the selection of a data candidate for correction processing of a target pixel;

FIG. 12(a) to FIG. 12(c) are drawings showing three examples of mode of the selection of a data candidate for correction processing of a target pixel;

FIG. 13(a) and FIG. 13(b) are drawings showing two examples of direction characteristic of a target pixel;

FIG. 14 is a flow chart showing a third flaw/dust correction processing;

FIG. 15 is a flow chart showing a first dividing processing of a flaw/dust area;

FIG. 16 is a drawing showing three partial areas in a flaw/dust area divided by a first dividing processing of the flaw/dust area;

FIG. 17 is a flow chart showing a second dividing processing of a flaw/dust area;

FIG. 18 is a drawing showing three partial areas in a flaw/dust area divided by a first dividing processing of the flaw/dust area;

FIG. 19 is a flow chart showing a fourth flaw/dust correction processing;

FIG. 20 is a flow chart showing a fifth flaw/dust correction processing;

FIG. 21 is a flow chart showing a sixth flaw/dust correction processing;

FIG. 22 is a flow chart showing an enlargement/reduction processing;

FIG. 23 is a flow chart showing a sharpness/graininess correction processing; and

FIG. 24 is a drawing showing the internal structure of a reflection original scanner 141.

### DETAILED DESCRIPTION OF THE PREFERRED EMBODIMENT

In the following, with reference to the attached drawings, the embodiment of this invention will be explained in detail. However, the scope of the invention is not limited to the examples shown in the drawings.

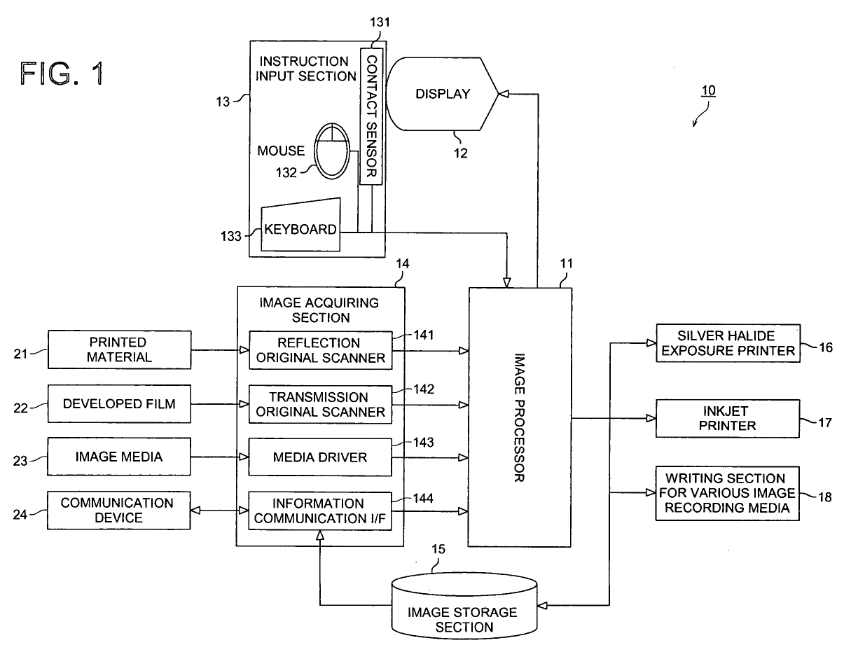

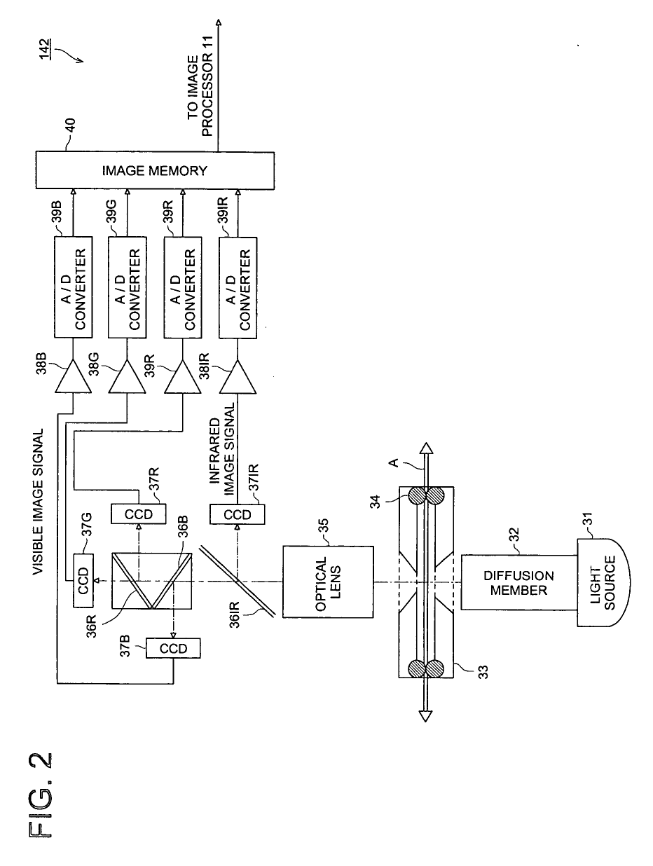

First, with reference to FIG. 1 and FIG. 2, the feature of an apparatus of this embodiment of the invention will be explained. FIG. 1 is a block diagram showing an image processing system 10 of this embodiment. FIG. 2 is a drawing showing the structure of a transmission original scanner 142 shown in FIG. 1.

As shown in FIG. 1, the image processing system 10 of this embodiment such as a digital mini-laboratory system has a structure equipped with an image processor 11, an image display section 12, an instruction input section 13, an image acquiring section 14, an image storage section 15, a silver halide exposure printer 16, an IJ (ink jet) printer 17, and a writing section for various image recording media 18.

The image processor 11 applies an image processing to the various kinds of image information acquired by the image acquiring section 14 and/or the image information stored in the image storage section 15 on the basis of various kinds of instruction information inputted at the instruction input section 13, and outputs the information to the image storage section 15, the silver halide exposure printer 16, the IJ printer 17, and the writing section for various image recording media 18. Further, the image processor 11 outputs image information to the image display section 12.

The image acquiring section 14 has a structure equipped with a reflection original scanner 141 for scanning an image recorded on a printed object 21 such as a photographic print, a printed object, and a work of pictorial art or calligraphy and acquiring image information, a transmission original scanner 142 for scanning an image recorded on a developed film 22 such as a negative film or a positive film and acquiring image information, a medium driver 143 for reading and acquiring image information recorded in an image medium such as a DSC (digital still camera), a CD-R, and an image memory card, and an information communication I/F 144 for receiving and acquiring image information from a communication means 24 such as the Internet and a LAN or receiving and acquiring image information stored in the image storage section 15. Input image information inputted from each of the acquisition portions 141 to 144 is outputted to the image processor 11.

The image display section 12 is made up of an LCD (Liquid Crystal Display), a CRT (Cathode Ray Tube), a PDP (Plasma Display Panel), or an EL (Electro-Luminescent) display, and carries out screen display of various kinds of display data in accordance with a display instruction outputted from the image processor 11.

The instruction input section 13 has a structure equipped with a touch sensor 131 as a touch panel provided in the display section 12 for acquiring a touch signal inputted by a touch of an operator and its position information on the screen to output them to the image processor 11, a mouse 132 for acquiring a position signal and a selection signal inputted by an operator and outputting them to the image processor 11, and a keyboard 133 equipped with a cursor key, numeral input keys, and various kinds of function key for acquiring a depress signal inputted by the depressing of a key by an operator and outputting it to the image processor 11.

The image storage section 15 is made up of an HDD (Hard Disk Drive), etc., and stores image information to be capable of being read and written. The silver halide exposure printer 16 prints out image information as an image on a photographic paper or a film by a silver halide exposure method. The IJ printer 17 prints out image information as an image on a recording sheet or the like by an ink jet method. The writing section for various recording media 18 writes image information in an image recording medium such as a flexible disk, a CD-R, or an image memory card, to record the information therein.

The image processor 11, using various kinds of method to be described later, carries out a flaw/dust processing for amending an image, which has been subjected to the influence of a flaw of its original and/or attached dust. Output image information, having been amended for its defect caused by a flaw/dust by a flaw/dust processing in the image processor 11, is subjected to color transformations in accordance with the output apparatus (at least one of the image storage section 15, the silver halide exposure printer 16, the IJ printer 17, and the writing section for various kinds of image recording medium 18), and is transmitted to the output apparatus. The silver halide exposure printer 16 and the IJ printer 17 print out the output image information received from the image processor 11. The writing section for various recording media 18 writes the output image information received from the image processor 11. The image storage section 15 stores the output image information received from the image processor 11. The image information stored in the image storage section 15 is accumulated to be capable of re-utilization as an image source by the readout of the image processor 11.

Besides, because the structure of the image processing system 10 is characterized by the image processor 11, as regards the kind and number of the structural portions of the image acquiring section 14, the image display section 12, the instruction input section 13, the silver halide exposure printer 16, the IJ printer 17, and the writing section for various recording media 18 are not to be limited to the example shown in FIG. 1.

Next, with reference to FIG. 2, the structure of the transmission original scanner 142 in the image acquiring section 14 of the image processing system 10 will be explained. The transmission original scanner 142 is equipped with a light source portion 31 for emitting light for scanning a transmission image, a diffusion member 32 for making light emitted from the light source portion 31 uniform (making light have no unevenness), a film carrier 33 for conveying a film A in the arrow mark direction by means of rollers 34 for conveying a film A in the one-dimensional direction, and an optical lens 35 for focusing a bundle of rays having passed the film A. The bundle of rays emitted from the light source portion 31 and emerging from the diffusion member 32 has a linear cross-sectional shape, and by the line-shaped bundle of rays and the conveyance of the film A, a light image corresponding to an image on the film A is to be transmitted.

Further, the transmission original scanner 142 is also equipped with dichroic filters 361R, 36B, and 36R, line CCD (Charge Coupled Device) sensors 371R, 37B, 37G, and 37R, analogue amplifiers 381R, 38B, 38G, and 38R, A/D converters 391R, 39B, 39G, and 39R, and an image storage 40.

A bundle of rays emerging from the optical lens 35 is split by the dichroic filters 361R, 36B, and 36R, the split bundles of rays are received by the line CCD sensors 371R, 37B, 37G, and 37R corresponding to the light of infrared region and light of colors blue (B), green (G), and red (R) respectively each forming an image, and the split light images are converted into digital signals by their respective A/D converters 391R, 39B, 39G, and 39R, to be stored in the image storage 40 for utilization. The above-mentioned line CCD sensors are arranged extending in the direction perpendicular to the conveyance direction of the film A; the array direction of the line CCD sensors is the main scanning direction, and the above-mentioned film conveyance direction is the sub-scanning direction.

The light of green (G) color region which has not been reflected but transmitted by the dichroic filters 361R, 36B, and 36R is received by the line CCD sensor 37G to form an image. Image information corresponding to the infrared region is invisible image information, and image information corresponding to each of the blue color region, green color region, and red color region is regarded as a component of visible image information. That is, visible image information is composite image information composed of image signals of the blue color region, green color region, and red color region (R image information, G image information, and B image information).

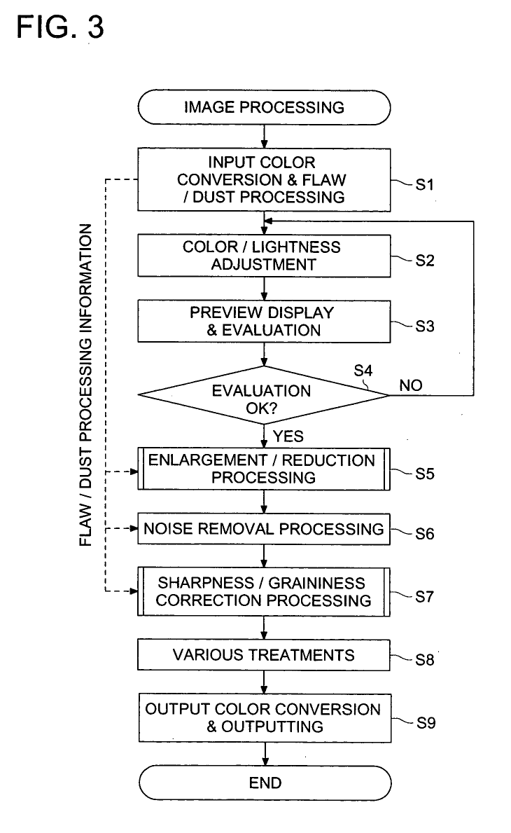

Next, with reference to FIG. 3 to FIG. 23, the operation of the image processing system 10 will be explained. FIG. 3 is a flow chart showing the image processing. First, with reference to FIG. 3, the image processing to be practiced in the image processor 11 of the image processing system 10 will be explained.

For example, in the image processor 11, there are provided a CPU, a RAM, and a storage device (all not shown in the drawing); an image processing program stored in the storage device is read out and stored in the RAM, and by the cooperation of the CPU and the image processing program in the RAM, image processing is practiced. The way of practice of each of the processings to be described below is the same as that of the processing in the image processor 11.

It is assumed that various kinds of image information have been acquired in the image acquiring section 14 (hereinafter referred to as acquired image information), and the acquired image information has been inputted in the image processor 11 beforehand. The image processing is a processing in which the visible image information of acquired image information is subjected to a specified processing and is outputted as output image information to the output sections 15 to 18 concerned. In the following, in cases where no particular comment is made, it is assumed that the subject of the processing is the image processor 11.

As shown in FIG. 3, first, an input color transformation is applied to acquired image information, and a flaw/dust processing to be described later is practiced (step S1). An input color transformation is a color transformation in accordance with the input characteristic of the acquisition portions 141 to 144 of the image acquisition section 14, and for example, it includes a processing for transforming signal values obtained through the digitizing of signals from the CCD sensors having received film transmission light into values in a unit system which is significant for image signals such as visual signal values or optical density values, and a processing for making the color tone represented in accordance with the spectral response of the image acquisition portions match to a standard color space. A flaw/dust processing is a processing for removing the influence of a flaw and/or dust on the image information acquisition source (for example, a film) to cause defective pixels to be produced from the visible image information of acquired image information. Further, an area on acquired image information resulting from a flaw and/or dust is referred to as a flaw/dust area.

Then, an instruction to make appropriate the color and lightness of the visible image information having been subjected to a flaw/dust processing is inputted from the instruction input section 13, to make a color/lightness adjustment (step S2). The visible image information, having been subjected to a color/lightness adjustment, is displayed on the image display section 12, the image information is visually referred to by an operator, and an evaluation concerning whether or not the color and lightness are appropriate is inputted from the instruction input section 13 (step S3).

Then, it is judged whether or not the inputted evaluation is OK (step S4). If the evaluation is NG (step S4: NO), the procedure moves to the step S2. Again, color and lightness is inputted by the operator for adjustment. If the evaluation is OK (step S4: YES), as occasion demands, on the basis of flaw/dust processing information, which is the information outputted in the flaw/dust processing in the step S1, an enlargement/reduction processing for enlarging or reducing the visible image information having been already subjected to a color/lightness adjustment to a desired size is carried out (step S5). To the visible image information having been subjected to the enlargement/reduction processing, a noise removal processing for removing noises is applied (step S6). To the visible image information having been subjected to the noise removal processing, on the basis of the flaw/dust processing information, a sharpness/graininess correction processing for suitably correcting the sharpness and graininess is applied (step S7). In the image processings of the steps S5 to S7, as will be described later, information on the flaw/dust processing obtained from the step S1 can be used as supplementary information.

Then, to the visible image information having been subjected to the sharpness/graininess processing, various kinds of processing such as a rotation processing, an insertion-composition processing to various kinds of image such as an image frame, and a character-putting processing are applied (step S8).

Then, to the visible image information having been subjected to the various kinds of processing, an output color transformation is applied. The output color transformation includes a processing for making it match with the color space corresponding to the output characteristic of the output sections 15 to 18. The visible image information, having been subjected to the output color transformation, is outputted to at least one of the output sections 15 to 18 (step S9), and the image processing is finished. The image information, having been subjected to the output color transformation, is subjected to a storage process in the image storage section 15, a recording process on a photosensitive material (for example, a photographic paper) by the silver halide exposure printer 16, a recording process on a recording sheet or the like by the IJ printer 17, and/or a recording process in one or more of the various kinds of recording medium by the writing section for various recording media 18. Further, the detailed description of the enlargement/reduction processing of the step S5 and the sharpness/graininess processing of the step S7 will be done later. Besides, the information acquired by the flaw/dust processing of the step S1 is used in the processing of the steps S5 to S7.

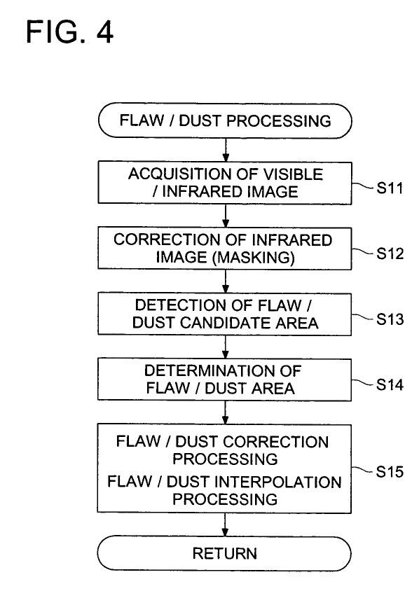

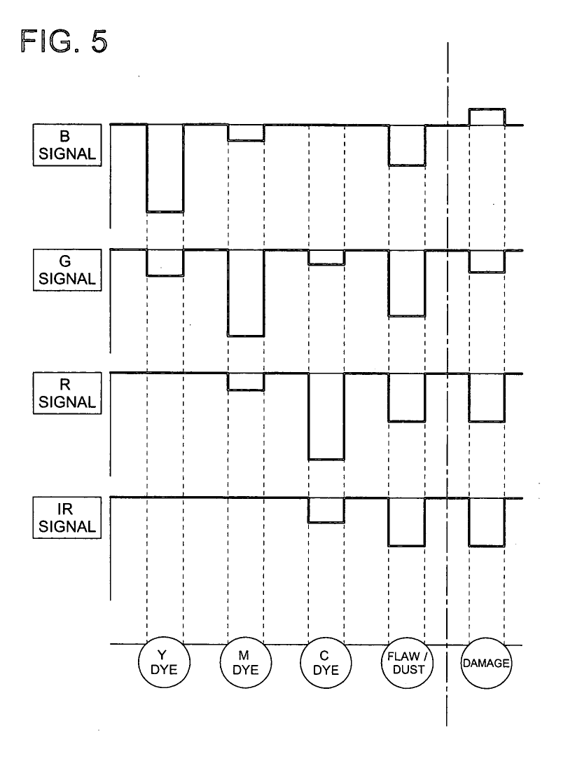

Next, with reference to FIG. 4 and FIG. 5, the flaw/dust processing of the step S1 in the image processing shown in FIG. 3 will be explained. FIG. 4 is a flow chart showing a flaw/dust processing. FIG. 5 is a drawing showing the light absorption signals of their respective wavelength regions.

As shown in FIG. 4, first, visible image information representing a visible image in acquired image information and infrared image information representing an infrared image are acquired (step S11). Then, the infrared image information is corrected by a masking processing (step S12).

FIG. 5 is a drawing in which the theory of extraction of flaw/dust information on the basis of infrared image information is represented in a schema. The dyes making up an image have different light absorption characteristics from one another, to produce a B signal, a G signal, and an R signal which are received by the CCD sensors. However, as regards infrared light, it is hardly subjected to absorption except for a small amount of absorption by the C dye. On the other hand, because a flaw and/or dust exhibits a property to absorb or diffuse both of visible light and infrared light, it is possible to detect a position where a flaw and/or dust exists by the observation of infrared image information. The “damage” at the right-side end represents a flaw in a condition such that it influences the image information carrier itself to make a part of the image information lost. In the example of the “damage” shown at the right-side end, the correlation (the way of variation of the signal values to become large or small) between the influence given by a damage to the infrared signal and the influence given by it to the visible signals is different from the case of the “flaw/dust”. This “damage” has a possibility of producing a problem to make a reverse correction in a case where the method of the patent literature 3 described in the conventional technology. However, as will be described later, in this embodiment, a flaw/dust processing which never produces a reverse correction is carried out.

As described above, the IR light is remarkably absorbed by a flaw, dust, or a damage portion, and is a little absorbed by the C dye. For this reason, in order to extract a flaw/dust, or a damage portion only, in the step S12, the absorption component in the C dye is removed by a masking processing; further, by the subtraction of the infrared standard data as infrared standard image information of the IR signal, infrared difference data indicating a flaw/dust, and a damage portion only is calculated, to specify the positions of a flaw, a dust particle, and a damage. Hereinafter, unless it is particularly referred to, the term “a flaw/dust (a flaw and/or dust)” represents “a flaw, dust, and/or a damage”.

Then, on the basis of the infrared image information having been subjected to a masking processing (infrared difference data concerning the infrared image information), a flaw/dust area of the infrared image information is detected, and a flaw/dust candidate area in the visible image information is detected on the basis of the flaw/dust area of the infrared image information (step S13). Subsequently, from the flaw/dust candidate area in the visible image information, a flaw/dust area in the visible image information is determined (step S14). On the basis of the flaw/dust area, a flaw/dust correction processing and a flaw/dust interpolation processing are applied to the visible image information (step S15), and the flaw/dust processing is finished. After the completion of the flaw/dust processing, the procedure moves to the next step (step S2 of FIG. 3).

Now, the difference between the flaw/dust correction processing and the flaw/dust interpolation processing in the step S15 will be explained. As regards a method of flaw/dust processing, in a general classification, two methods are known to the public. One is a method in which an image signal is subjected to attenuation or the like which has been caused by the influence of a flaw and/or dust and a correction is made for this portion of influence, and this is defined as a correction processing in this embodiment. The other is a method in which an attempt to restore the image data of an area having its image information lost by the influence of a flaw and/or dust is carried out by the utilization of the information of the surrounding pixels, and this is defined as an interpolation processing in this embodiment.

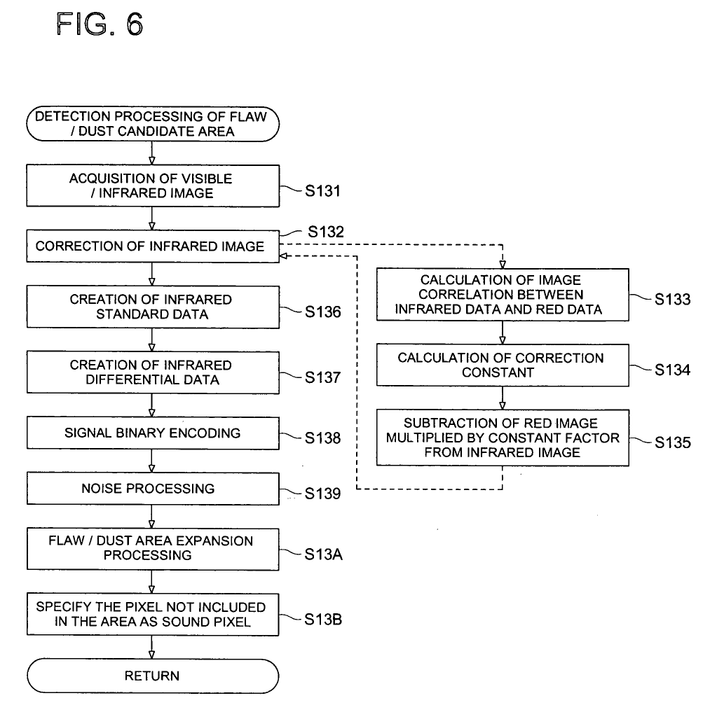

Next, with reference to FIG. 6, a flaw/dust candidate area detection processing corresponding to the steps S11 to S13 in the flaw/dust processing of FIG. 4 will be explained. FIG. 6 is a flow chart showing a flaw/dust candidate area detection processing. First, the step S131 is the same as the step S11. Then, infrared image information is corrected (step S132). Now, the step S132 will be explained in detail.

The image data correlation between the data of the infrared image information (signal values) and the red data in the visible image information is calculated (step S133). Then, a correction constant for removing the red component corresponding to the C dye from the infrared image information is calculated (step S134). Then, each of the data in the infrared image information is multiplied by the correction constant, and the product is subtracted from each of the data in the infrared image information (step S135). In this way, red component is removed from the infrared image information, and infrared image information representing only the influence of flaws and/or dust is obtained.

Further, after the step S132, infrared standard data as signal values in the case where no absorption due to the dye, flaws, etc. is present in the infrared image information are created (step S136). As regards the creation of the infrared standard data, first, it is set a spatial frequency band pass filter which is previously determined corresponding to the forms of various kinds of film or the image reading condition of the various kinds of scanner. For the spatial frequency band pass filter, various kinds of noise filter as set forth in the publication of the unexamined patent application 2002-262094 to be employed for visible image information can be utilized. Now, an example of a representative spatial frequency band pass filter to be used in the noise processing and the sharpness correction processing will be explained simply.

First, numbering of data in image information is carried out in a manner as shown in Table 1 noted in the following. Table 1 is a table showing the signal value of each of the pixels in the image information and the positional relation of the pixels.

TABLE 1

| | | | | | | | | |
|---|---|---|---|---|---|---|---|---|
| p11 | p12 | p13 | p14 | p15 | p16 | p17 | p18 | p19 |
| p21 | p22 | p23 | p24 | p25 | p26 | p27 | p28 | p29 |
| p31 | p32 | p33 | p34 | p35 | p36 | p37 | p38 | p39 |
| p41 | p42 | p43 | p44 | p45 | p47 | p47 | p48 | p49 |
| p51 | p52 | p53 | p54 | p55 | p56 | p57 | p58 | p59 |
| p61 | p62 | p63 | p64 | p65 | p66 | p67 | p68 | p69 |
| p71 | p72 | p73 | p74 | p75 | p76 | p77 | p78 | p79 |
| p81 | p82 | p83 | p84 | p85 | p86 | p87 | p88 | p89 |
| p91 | p92 | p93 | p94 | p95 | p96 | p97 | p98 | p99 |

(Sharpness Enhancing or Smoothing Filter)

In the case of a sharpness enhancing filter or a smoothing filter, by the use of data of the 5×5 pixels in the central part, the following calculation result is obtained.

FP1=(p33+p 37+p73+p77)×fildat[1]

+(p34+p36+p43+p47+p74+p76+p63+p67)×fildat[2]

+(p35+p53+p57+p75)×fildat[3]

+(p44+p46+p64+p66)×fildat[5]

+(p45+p54+p56+p65)×fildat[6]

+p55×fildat[7],

FP1=FP1/divdat,

where fildat[1] to fildat[7] are specified constants.

Further, for FP1, limitations described below are provided.

FP1>0 and FP1<a threshold value F:FP1=0

FP1>0 and FP1≧a threshold value F:FP1=FP1−a threshold value F

FP1<0 and −FP1<a threshold value F:FP1=0

FP1<0 and −FP1≧a threshold value F:FP1=FP1+a threshold value F

FP1>0 and FP1>an upper limit value:FP1=an upper limit value

FP1<0 and FP1<a lower limit value:FP1=a lower limit value

Then, by the following operation, a new central pixel value p55′ is obtained.

p55′=p55+FP1.

This example of processing is particularly desirable in the processing of an image from a silver halide film, and is an example of practice of an edge enhancement filter of 5×5 pixels. With the value of the divdat made larger, the effect of the sharpness enhancement filter becomes weaker, and with it made smaller, the effect of the sharpness enhancement filter becomes stronger. If the upper limit value and the lower limit value is determined to be small, a fault that a gray-white-fleck (of independent points) noise is extremely enhanced is lightened, and a smooth tone reproduction can be obtained; if the limit values are determined to be large or no limit is provided, a natural edge enhancement effect can be obtained.

Further, by a change of the value of the fildats, the filter functions also as a smoothing filter. In a case where it is not necessary to set a threshold value, the following equation can be utilized, which makes it possible to design a smoothing filter simply.

Using the data of 5×5 pixels in the central part, one can carry out the following operations, to obtain a new central pixel value p55′.

p55′=(p33+p37+p73+p77)×fildat[1]

+(p34+p36+p43+p47+p74+p76+p63+p67)×fildat[2]

+(p35+p53+p57+p75)×fildat[3]

+(p44+p46+p64+p65)×fildat[5]

+(p45+p54+p56+p65)×fildat[6]

+p55×fildat]7],

FP1=FP1/divdat,

where fildat[1] to fildat[7] are specified constants.

These various kinds of parameter can be defined as correction values, and in accordance with the purpose, they can be altered for each of the areas.

(Band Cut Filter)

In the case of a band cut filter, using an image data of 9×9 pixels, one can obtain the following result of operation.

FP2=(p13+p17+p24+p25+p26+p31+p33+p34

+p35×4+p36+p37+p39

+p42+p43+p44×3+p46×3+p47+p48

+p52+p53×4+p57×4+p58

+p62+p63+p64×3+p66×3+p67+p68

+p75×4+p76+p77+p79

+p93+p97+p84+p85+p86+p71+p73+p74

−(p55+p54+p56+p65+p46)×12)/64.

Further, the following limit is set for FP2.

abs(FP2)≦threshold value 2:Leave FP2 as it is. Pass the calculation on and after that.

FP2>threshold value 2:FP2=threshold value 2

−(FP2−threshold value 2),

where FP2 is made zero (=0) if FP2 becomes negative (<0).

FP2<−(threshold value 2):FP2=(−(threshold value 2)

−FP2)−threshold value 2,

where FP2 is made zero (=0) if FP2 becomes positive (>0). Further, a new central pixel value p55′ is obtained from the following operation.

p55′=p55+FP2.

This example of processing is an example of practice of a band cut filter of 9×9 pixels. With the threshold value 2 made larger, the signal removal effect in the spatial frequency band of target becomes larger, and the low-frequency variation of the signal can be suppressed strongly. It is possible to define these various kinds of parameter as correction values; further, by the changing of the range of reference of surrounding data, the characteristic can be adjusted, and can be altered for each of the regions or for each of the machine models.

(Noise Correction)

In noise correction, numbering of pixels in image data is carried out in a manner as shown in Table 2 noted below. Table 2 is a table showing the signal value of pixels in image information and the positional relation of the pixels, where P denotes the central pixel value and X's and Y's denote peripheral pixel values.

TABLE 2

| | | | | | | | | |
|---|---|---|---|---|---|---|---|---|
| | | | | Y4′ | | | | |
| | | | | Y3′ | | | | |
| | | | | Y2′ | | | | |
| | | | | Y1′ | | | | |
| X4′ | X3′ | X2′ | X1′ | P | X1 | X2 | X3 | X4 |
| | | | | Y1 | | | | |
| | | | | Y2 | | | | |
| | | | | Y3 | | | | |
| | | | | Y4 | | | | |

As regards the X-direction, for the innermost combination (X1 and X1′), if the following inequality is satisfied, X1 and X1′ are entered in a data group for averaging:

abs(X1′+X1−2×P)<a threshold value.

Further, this operation is repeated for the one-pixel outer combination, next outer combination, - - - , until the above-mentioned judgement inequality is not satisfied, or up to a maximum radius (for example, 4 pixels) set beforehand as an initial value.

Further, as regards the Y-direction, a similar procedure is repeated.

Then, the simple average value of data having been entered in the data group and the central pixel value P is calculated, and it is defined as a new central pixel value P′.

In the above-mentioned method, if the threshold value is determined to be large, the noise removal effect becomes large, and on the other hand, fine details sometimes disappear. Further, by switching over “the maximum radius set beforehand as an initial value”, one can change the degree of magnitude of a noise that can be removed. In this example, there are above-mentioned two parameters, whose set values can be changed for each of the areas.

To return to the explanation of the flow, for example, a spatial frequency band pass filter as described above is applied to the infrared image information, and a stronger noise cut filter is applied to it; this gives data with flaw/dust information removed, which are defined as infrared standard data. By this, even in a case where a some amount of non-uniformity of light quantity remains in the infrared image information, by cutting the spatial frequency band corresponding to the non-uniformity of light quantity, one can acquire a stable infrared standard data. Of course, if the infrared image information has been subjected to a sufficient shading correction, the infrared standard data may be obtained through a procedure such that, as occasion demands, a simple smoothing filter is applied to the infrared image information, and then, its maximum data is obtained to be defined as a fixed constant in the image frame.

Then, the infrared standard data is subtracted from the infrared image information after the infrared correction obtained from the step S132 (S135), and infrared difference data as signal values of only the flaw/dust components are created (step S137). At this time, a noise filter is applied to the corrected infrared image information as occasion demands. In a system where an overall attenuation of the infrared signal becomes remarkable due to the application of a noise filter also to the infrared image information, in a case where the S/N ratio of the infrared image is worse than a usual one, by the application of a noise filter of only a required effect, a satisfactory result without any abnormal correction can be obtained.

Then, an appropriate threshold value is determined, and infrared difference data are binarized on the basis of the threshold value (step S138). The binarized infrared difference data are subjected to a noise processing (step S139). In the noise processing, it is appropriate that a smoothing process using a smoothing filter is done, and then, the signal values are binarized again.

In the step S139 of this embodiment, as an example of another noise filter, it is utilized a method in which removal of isolation points is carried out by the practice of an erosion (or closing: hereinafter referred to as closing) processing which is generally known as one mode of morphology processing.

The subsequent procedures of the flaw/dust candidate area detection processing will be explained. The infrared difference data having been subjected to the noise processing indicate flaw/dust an area on the infrared image information, and in order to apply the area to the visible image, a flaw/dust area expansion processing of the infrared image information is carried out (step S13A). A specified amount of expansion is made in order that the flaw/dust area on the visible image information is certainly included in the flaw/dust area of the infrared image information. For the flaw/dust area expansion processing, a necessary amount of dilation (or opening, hereinafter referred to as opening) processing which is known as one mode of morphology processing is practiced. In the case where a smoothing filter or another noise filter is utilized for the above-mentioned noise filter, also through an adjustment of the threshold value being carried out at the time of re-digitization of the signal values, a processing similar to the flaw/dust area expansion processing can be made.

Then, pixels of the visible image information corresponding to the pixels not included in the expanded flaw/dust candidate area of the infrared image information are defined as sound pixels (step S13B), and the flaw/dust candidate area detection processing is finished. The area of pixels which are not sound pixels of the visible image information is defined as a flaw/dust candidate area of the visible image information. After the completion of the flaw/dust candidate area detection processing, the procedure moves to the next step (the step S14 of FIG. 4).

In addition, the method of determining a flaw/dust candidate area is not limited to one method. In addition to a method using an infrared image as this embodiment, it is also appropriate a method in which surface reflection image data are taken by means of a reflection original scanner, and a flaw/dust candidate area is obtained from information representing the surface discontinuity. A reflection original scanner for carrying out this method will be described later. As regards another method, in the case of a transmission original, also it is appropriate that, through the switching-over of the nature of irradiation light, for example, between transmission light and reflection light, or the switching-over of the light source between a converging light source for irradiating a film with a parallel bundle of rays and a diffuse light source for irradiating a film with soft light by means of a diffusion box, and the acquisition of image data for each of both the conditions, a flaw/dust candidate area is detected from the difference of data between the two conditions.

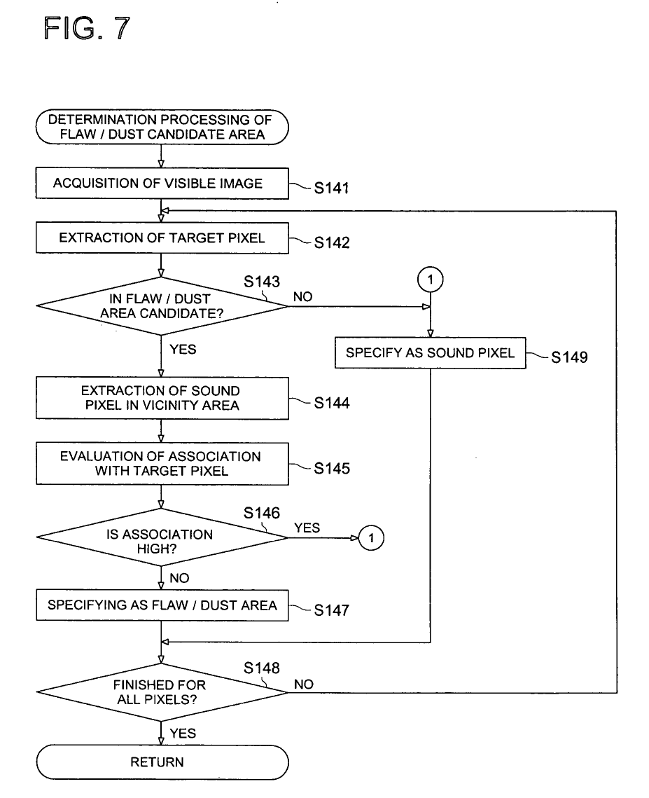

Next, with reference to FIG. 7, a flaw/dust area determination processing of the step S14 in the flaw/dust processing shown in FIG. 4 will be explained. FIG. 7 is a flow chart showing a flaw/dust area determination processing. The flaw/dust area determination processing is a processing for determining a flaw/dust area through the excluding of sound pixels out of the flaw/dust candidate area of visible image information.

As shown in FIG. 7, visible image information is acquired in the same way as the step S131 (step S141). A pixel is extracted from the acquired image information as a target pixel (step S142). Then, whether or not the target pixel is located in the flaw/dust candidate area of the visible image information is judged (step S143). If the target pixel exists in the flaw/dust candidate area of the visible image information (step S143: YES), sound pixels in the neighborhood of the target pixel are extracted (step S144). Then, the association between the extracted sound pixels and the target pixel is evaluated (step S145). Then, whether or not the association between the target pixel and the neighboring sound pixels is high is judged (step S146).

As regards the evaluation of the association between the target pixel and the neighboring sound pixels, a variety of ways can be considered. For example, a pixel such that the absolute value of the signal value difference between itself and the target pixel falls within a specified threshold range is extracted out of the neighboring sound pixels, this procedure is repeated, and if the number of such pixels is equal to or greater than a specified number, the target pixel can be defined as a sound pixel. Further, the above-mentioned specified threshold value may be a fixed value, but, for example, in the case where a noise filter functions in a later stage of the image processing, it is also appropriate to determine the threshold value in accordance with the strength of the filter (in a case where the noise filter has a threshold value, the magnitude of the threshold value). By doing this way, because the influence of microscopic flaws is removed by the noise filter at the later stage, it is not necessary to apply a flaw/dust processing for such microscopic flaws, which makes it possible to decrease the number of areas requiring a flaw/dust processing to a minimum, to improve the image processing capability.

If the association is not high (step S146: NO), the target pixel is determined to be a pixel existing in a flaw/dust area (step S147). Then, it is judged whether or not all the pixels have been extracted in the step S142 (step S148). If all the pixels have been extracted (step S148: YES), the flaw/dust area determination processing is finished.

If the target pixel is not located in the flaw/dust candidate area of the visible image information (step S143: NO), or the association is high (step S146: YES), the target pixel is defined as a sound pixel (step S149), and the procedure moves to the step S148. If all the pixels have not been extracted (step S148: NO), the procedure moves to the step S142. After the completion of the flaw/dust area determination processing, the procedure moves to the next step (step S15 of FIG. 4).

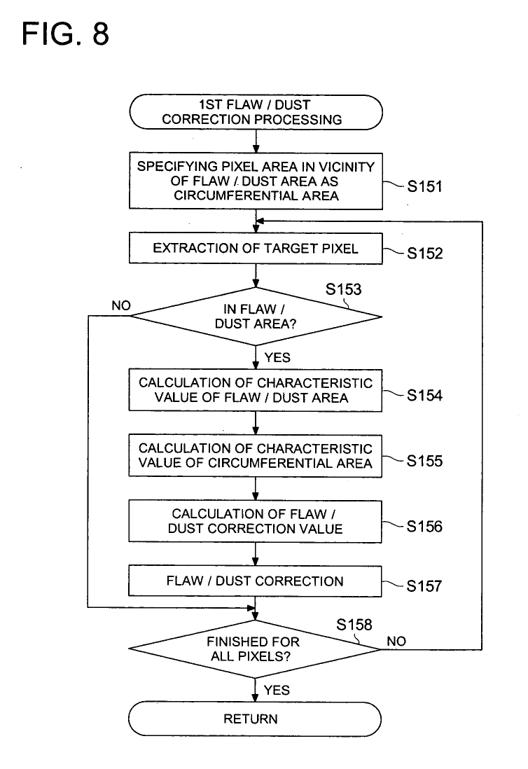

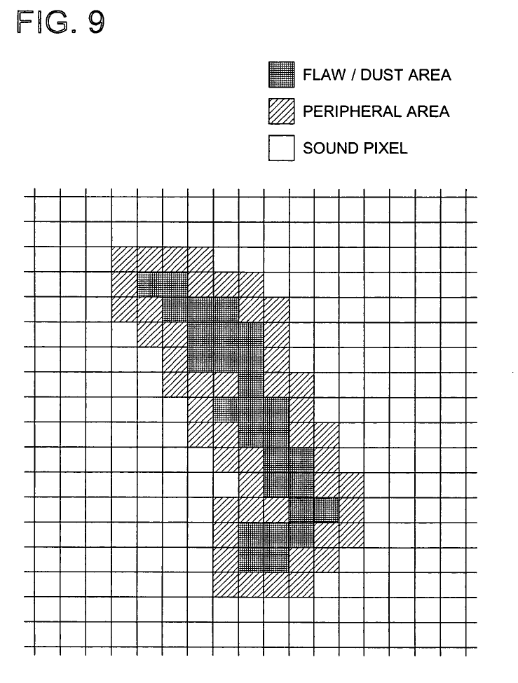

Next, with reference to FIG. 8 and FIG. 9, a first flaw/dust correction processing as an example of practice of the flaw/dust correction processing of the step S15 in the flaw/dust processing shown in FIG. 4 will be explained. FIG. 8 is a flow chart showing the first flaw/dust correction processing. FIG. 9 is a drawing showing a flaw/dust area and its peripheral area. The first flaw/dust correction processing is an example of a method for carrying out a correction processing using visible image information.

As shown in FIG. 8, first, an area of pixels in the neighborhood of a flaw/dust area of the visible image information which has already been obtained is defined as a peripheral area (step S151). For example, as shown in FIG. 9, with the specified range of the neighboring pixels determined to be one pixel, the area of sound pixels in the neighborhood of a flaw/dust area is defined as the peripheral area. Then, one pixel in the visible image information is extracted as a target pixel (step S152). Then, whether or not the extracted target pixel is located in a flaw/dust area is judged (step S153).

If the target pixel is not located in a flaw/dust area (step S153: NO), the procedure moves to the step S158. If the target pixel is located in a flaw/dust area (step S153: YES), a flaw/dust area characteristic value of the target pixel is calculated (step S154). The flaw/dust area characteristic value is a characteristic value to be calculated by the use of data of pixels within a specified distance from the target pixel in the flaw/dust area, and for example, it is defined as the average of the values of the pixels within the specified distance in the flaw/dust area. Then, a peripheral area characteristic value of the target pixel is calculated (step S155). The peripheral area characteristic value is a characteristic value calculated by the use of the values of the pixels in the peripheral area within the specified distance from the target pixel, and for example, it is defined as the average of the values of the pixels within the specified distance in the peripheral area. Further, the calculation of a flaw/dust area characteristic value or a peripheral area characteristic value may also be carried out by the use of a statistical method such that, for example, absound data are excluded, and after that, the mode (most frequent value) is obtained.

Then, on the basis of a between-characteristic value difference which is the difference between the calculated flaw/dust area characteristic value and peripheral area characteristic value, a visible image correction value is calculated as a flaw/dust correction value (step S156). By the use of the calculated flaw/dust correction value (visible image correction value), a flaw/dust correction is applied to the target pixel (step S157). Then, it is judged whether or not all the pixels in the visible image information have been extracted as a target pixel each in the step S152 (step S158). If all the pixels have been extracted (step S158: YES), the first flaw/dust correction processing is finished. If not all the pixels have been extracted (step S158: NO), the procedure moves to the step S152, and a pixel which has not been extracted is extracted as the next target pixel. After the completion of the first flaw/dust correction processing, the procedure moves to the next step (the flaw/dust interpolation processing of the step 15 of FIG. 4 or the step S2 of FIG. 3).

Generally speaking, as regards the influence of flaws and/or dust, the form of the area subjected to it is various; however, there is not a large difference to be regarded as important in the degree of influence given to each pixel between neighboring pixels in a flaw/dust area, and a visually desirable correction result can be obtained by the first flaw/dust correction processing. Further, by the first flaw/dust correction processing, it is possible to practice a correction of a flaw/dust area by the use of only an actually necessary image (visible image information in this case); therefore, for example, even in a case where there are large difference in the MTF characteristic or the flare characteristic between the infrared image information and the visible image information, it is possible to actualize a correction performance which brings about neither an excessive correction nor an insufficient correction. Further, even in a case where some data in the visible image information are lost (for example, in a case where a damage exists on a film), a satisfactory processing result which makes only a small risk of reverse correction and does not make the influence of the defect noticeable can be obtained.

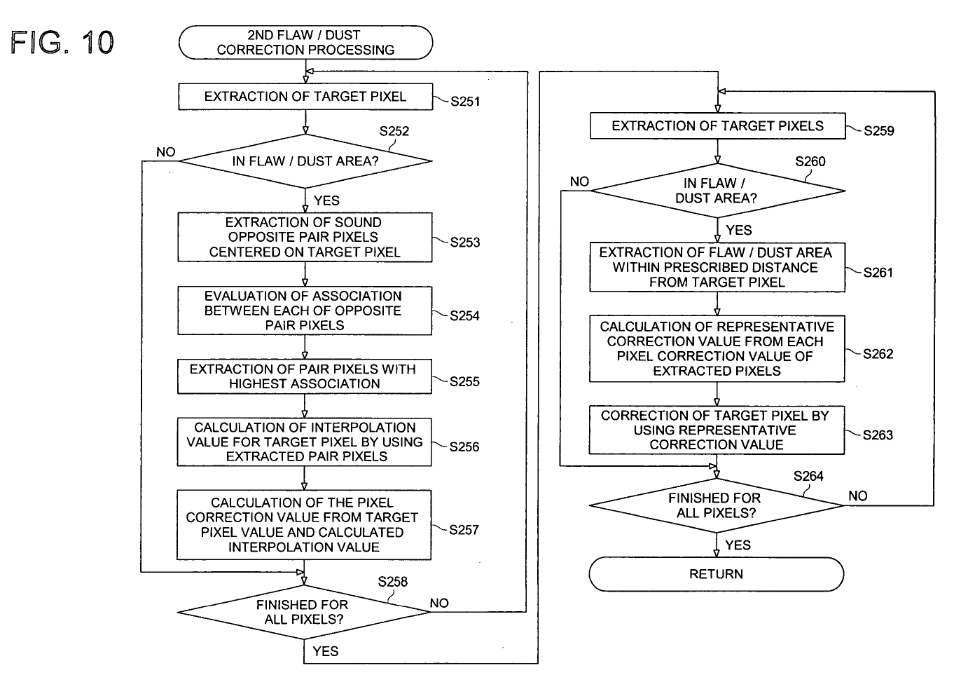

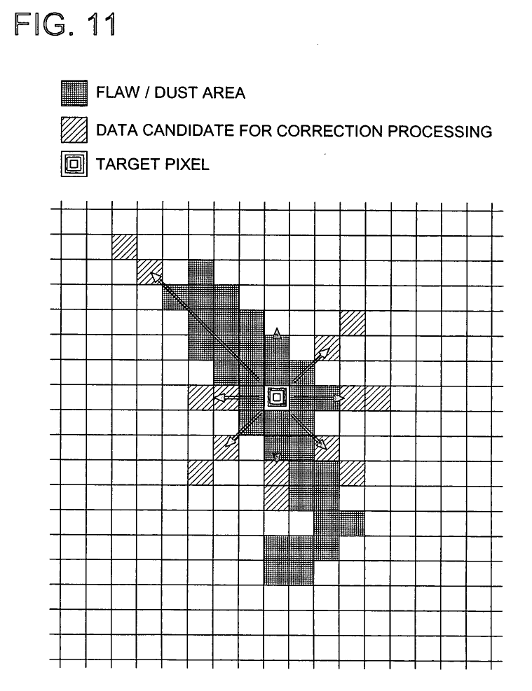

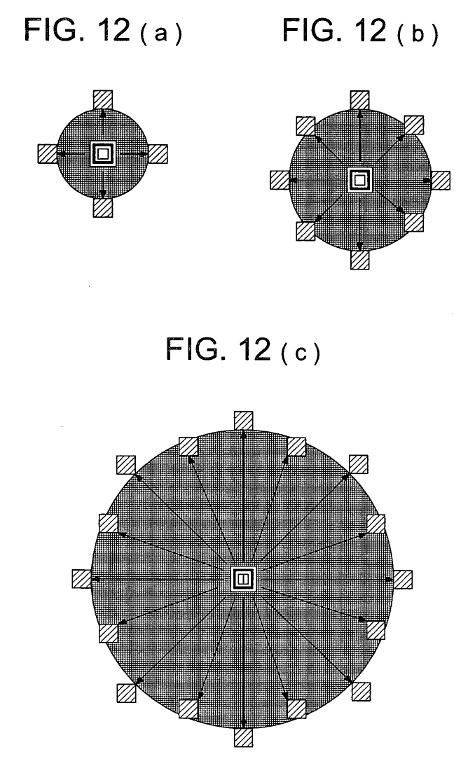

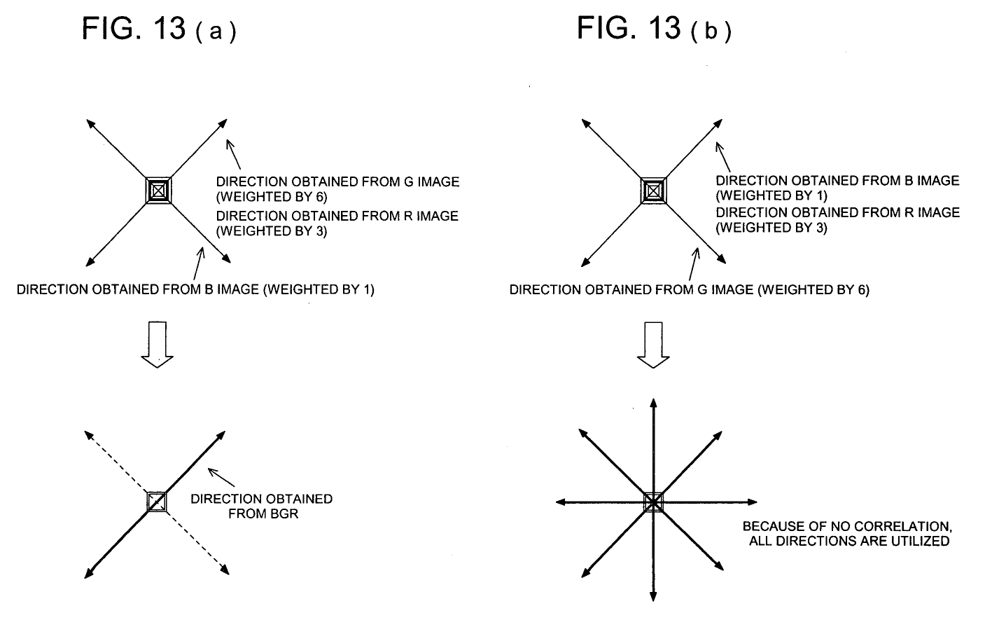

Next, with reference to FIG. 10 to FIG. 13, a second flaw/dust correction processing as one mode of practice of the flaw/dust correction processing of the step S15 in the flaw/dust processing shown in FIG. 4 will be explained. FIG. 10 is a flow chart showing the second flaw/dust correction processing. FIG. 11 is a drawing showing the selection of a data candidate for the correction processing of a target pixel. FIG. 12(a) to FIG. 12(c) are drawings showing three examples of mode of the selection of data candidate for the correction processing of a target pixel. FIG. 13(a) and FIG. 13(b) are drawings showing two examples of direction characteristic of a target pixel.

As shown in FIG. 10, first, one pixel is extracted as a target pixel from visible image information (step S251). Then, it is judged whether or not the target pixel is located in a flaw/dust area (step S252). If the target pixel is not located in a flaw/dust area (step S252: NO), the procedure moves to the step S258.

If the target pixel is located in a flaw/dust area (step S252: YES), a pair of sound pixels which are opposite to each other with respect to the target pixel located at the center are extracted (step S253). For example, as shown in FIG. 11, in each of the four directions of the vertical, lateral, and oblique directions, a pair of sound pixels opposite to each other are extracted. Further, as shown in FIG. 12(a) to FIG. 12(c), it is appropriate to increase or decrease the number of the directions of extraction in accordance with the size (distance between the pixels opposite to each other) of the flaw/dust area. In FIG. 12, the number of the directions of extraction is increased more the larger the distance between the opposite pixels becomes.

Then, the evaluation of association between the extracted pixels opposite to each other is made (step S254). For example, the association is evaluated by the difference data in the signal value between the pixels opposite to each other, and the association is regarded as higher the smaller the difference data becomes. Then, a pair of pixels opposite to each other having the highest association are extracted (step S255).

Then, by the use of the values of the extracted pixels opposite to each other, an interpolation calculation value, which is an estimation of the signal value of the target pixel, is calculated (step S256). Then, a pixel correction value is calculated from the signal value of the target pixel and the interpolation calculation value (step S257). The pixel correction value is a provisional flaw/dust correction value, and for example, it is the difference data between the target pixel value and the interpolation calculation value. Then, it is judged whether or not all the pixels in the visible image information have been extracted as a target pixel each in the step S251 (step S258). If not all the pixels have been extracted (step S258: NO), the procedure moves to the step S251, and a pixel which has not been extracted is extracted as the next target pixel.

In addition, in the steps S251 to S258, a pair of pixels opposite to each other in the high-association direction are extracted as the basis of interpolation; however, also it is appropriate that the above-mentioned direction is obtained for each of the color images of B, G, and R, from the result, that is, from the reliability information such as the degree of accord of the direction among the color images, a direction to be used commonly for the images of B, G, and R is determined, and a pair of pixels opposite to each other in that direction are extracted. For example, it is shown in FIG. 13(a) that the directions obtained from the G image information and R image information are the same as each other, a weighting factor of 6 is given to the direction obtained from the G image information, a weighting factor of 3 is given to the direction obtained from the R image information, and a weighting factor of 1 is given to the direction obtained from the B image information, which is perpendicular to the above-mentioned direction. In this case, with the weighting factors taken into consideration concerning the direction obtained from the images of B, G, and R, the direction of acquisition of pixels for the basis of interpolation is determined to be the direction shown in the drawing. The reason is that, if the directions of interpolation for the images of B, G, and R are not made to agree with one another, there is some possibility of unnatural coloring of pixels after interpolation. Further, as shown in FIG. 13(b), in the case where no directivity is present in the weighting of the directions shown, it is also appropriate to make an interpolation without taking a particular direction for the direction of acquisition of pixels for the interpolation basis. Further, in the processings from the step S251 to the step S256, even though each of the processings is not a processing of the above-mentioned desirable embodiment as it is, it can be employed so long as it is such that the interpolation signal value of the target pixel is estimated by the signal values of the peripheral sound pixels. For example, it is also possible to select it out of a method using an interpolation from the nearest neighbor pixels, a method using an interpolation from all the peripheral pixels, a method using a pattern matching processing based on the detection of a repeated pattern, etc., a method in which the whole of image information is evaluated by the use of area dividing, pattern recognition, etc., it is predicted what kind of image area the defective pixels originally are, and on the basis of its result, the signal value of a target pixel is estimated.

The above-mentioned weighting is based on the visibility factor, to state it concretely, based on the weighting for the images of B, G, and R to be used in the color transformation in an NTSC system. For example, the weighting for blue is determined to be a low value because an observer has a low sensitivity to blue, and the weighting for green is determined to be a high value because an observer has a high sensitivity to green. However, it is not limited to this, and also it is possible to use a method to obtain reliability information separately at the time of determination of the vector. As regards the reliability information, it is appropriate to obtain the reliability, for example, through a statistical processing of the difference in the index of selection between the selected one and the others not selected, when the direction concerned is selected out of a plurality of directions.

If all the pixels have been extracted (step S258: YES), the procedure moves to the flow shown in the right side of the drawing. First, one pixel is extracted as a target pixel from image information (step S259). Then, it is judged whether or not the target pixel is located in a flaw/dust area (step S260). If the target pixel is not located in a flaw/dust area (step S260: NO), the procedure moves to the step S264.

If the target pixel is located in a flaw/dust area (step S260: YES), pixels of the flaw/dust area within a specified area with respect to the target pixel located at the center are extracted (step S261). The specified area is, for example, a matrix of 5×5 pixels. Then, a representative correction value is calculated from the pixel correction values of their respective pixels extracted from the flaw/dust area within the specified area (step S262). For the pixel correction value, the pixel correction value which has been calculated in the step S257 is used, and for example, the average value of the pixel correction values of the pixels concerned is defined as the representative correction value. Further, for the calculation of the representative correction value, it is also possible to use a statistical method. Then, by the use of the calculated representative value, the target pixel value of the visible image region is corrected (step S263). To be concrete, if the signal value of the target pixel corresponds to its energy quantity, a multiplication or a division operation of the correction value and the signal value of the target pixel is done, and if the signal value is a density data, an addition operation or a subtraction operation is done.

Then, it is judged whether or not all the pixels of the visible image information have been extracted as a target pixel each in the step S259 (step S264). If not all the pixels have been extracted (step S264: NO), the procedure moves to the step S259, where a pixel which has not been extracted yet is extracted as the next target pixel. If all the pixels have already been extracted (step S264: YES), the second flaw/dust correction processing is finished. After the completion of the second flaw/dust correction processing, the procedure moves to the next step (the flaw/dust interpolation processing of the step S15 of FIG. 4, or the step S2 of FIG. 3).

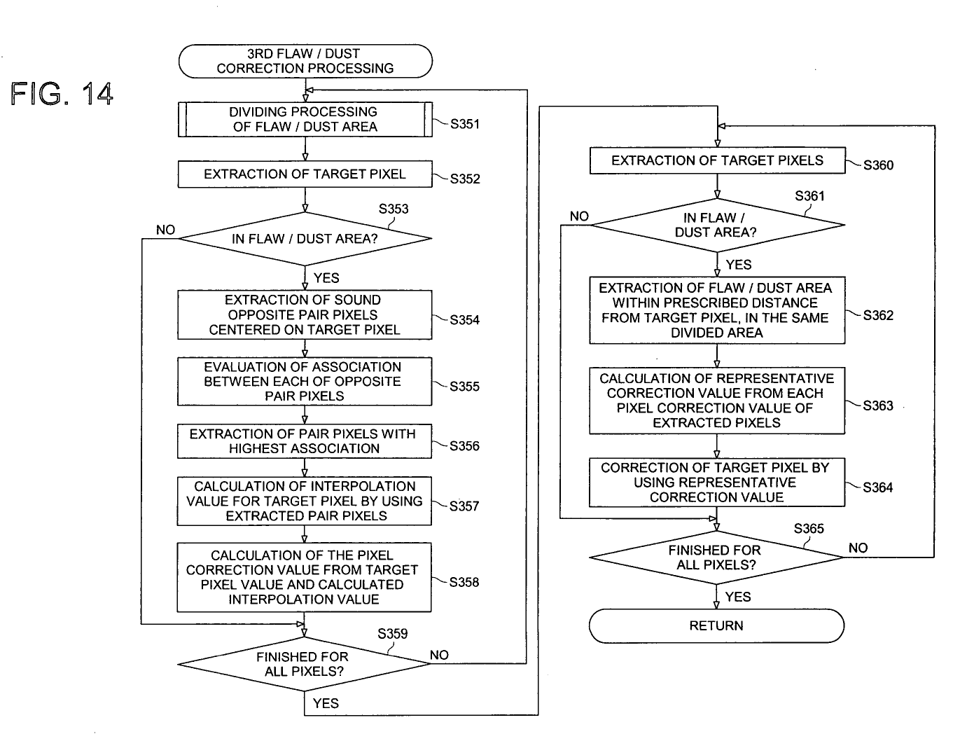

Next, with reference to FIG. 14, a third flaw/dust correction processing as a mode of practice of the flaw/dust correction processing of the step S15 in the flaw/dust processing shown in FIG. 4 will be explained. FIG. 14 is a flow chart showing the third flaw/dust correction processing. The first flaw/dust correction processing and the second flaw/dust correction processing shown in FIG. 10 and FIG. 12 respectively are based on the assumption that the influence given by a flaw/dust in a single (or a neighboring) flaw/dust area to the image information is monotonous. In most cases, a sufficient correction result can be obtained by this processing merely, but there is a situation such that, in a case where the influence of flaw/dust extends gently over a broad range, it is difficult to say that the influence given by a flaw/dust in a single area to the image information is monotonous. In such a case, it is appropriate to divide a flaw/dust area into several partial areas, to use such a correction method as the first or the second flaw/dust correction processing for each of the divisional areas. The third flaw/dust correction processing is a flaw/dust correction processing in which a flaw/dust area is divided into several partial areas.

As shown in FIG. 14, first, a dividing processing of a flaw/dust area for dividing a flaw/dust area of visible image information into two or more partial areas is practiced (step S351). Two examples of the dividing processing of a flaw/dust area of the step S351 will be described later. Then, steps S352 to S359 are practiced. The steps S352 to S359 are processings similar to the steps S252 to S258 of the second flaw/dust correction processing. Then, if all the pixels have been extracted (step S359: YES), the procedure moves to the right-side flow in the drawing. First, one pixel is extracted as a target pixel from the visible image information (step S360). Then, it is judged whether or not the target pixel is located in a flaw/dust area (step S361). If the target pixel is not located in a flaw/dust area (step S361: NO), the procedure moves to the step S365.

If the target pixel is located in a flaw/dust area (step S361: YES), pixels of the flaw/dust area within a specified area with respect to the target pixel located at the center and in the same partial area are extracted (step S362). The partial area is the partial area in the flaw/dust area set in the step S351. Then, in the same way as the step S262, a representative correction value is calculated from the pixel correction values of their respective pixels extracted from the flaw/dust area located within the specified area and in the same partial area (step S363). Then, by the use of the calculated representative value, the target pixel value of the visible image region is corrected (step S365). To be concrete, if the signal value of the target pixel corresponds to its energy quantity, a multiplication or a division operation of the correction value and the signal value of the target pixel is done, and if the signal value is a density data, an addition operation or a subtraction operation is done.

Then, it is judged whether or not all the pixels of the visible image information have been extracted as a target pixel each in the step S360 (step S365). If not all the pixels have been extracted (step S365: NO), the procedure moves to the step S360, where a pixel which has not been extracted yet is extracted as the next target pixel. If all the pixels have already been extracted (step S365: YES), the third flaw/dust correction processing is finished. After the completion of the third flaw/dust correction processing, the procedure moves to the next step (the flaw/dust interpolation processing of the step S15 of FIG. 4, or the step S2 of FIG. 3).

By the third flaw/dust correction processing, for a flaw/dust area of a broader characteristic, a satisfactory correction result can be obtained.

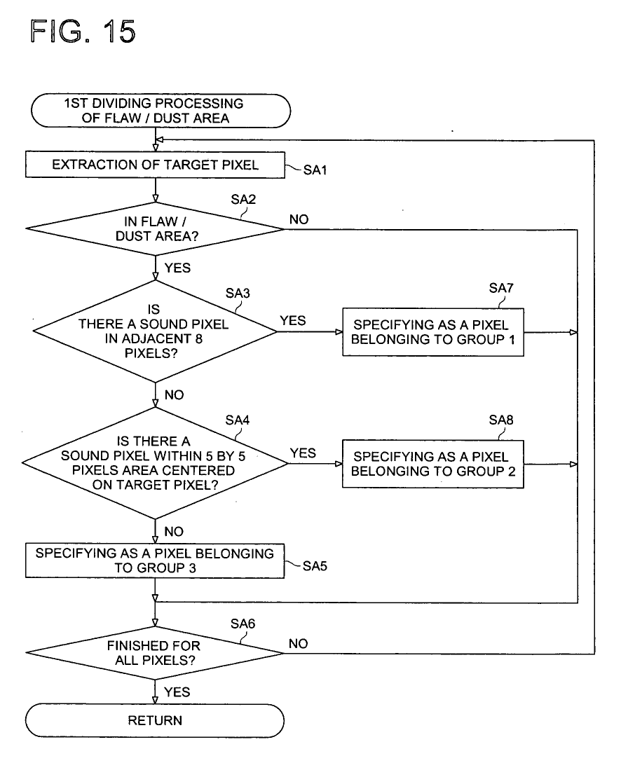

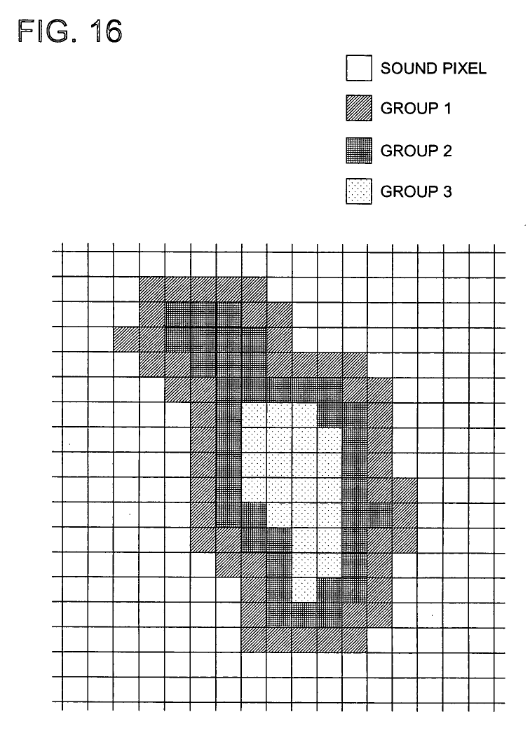

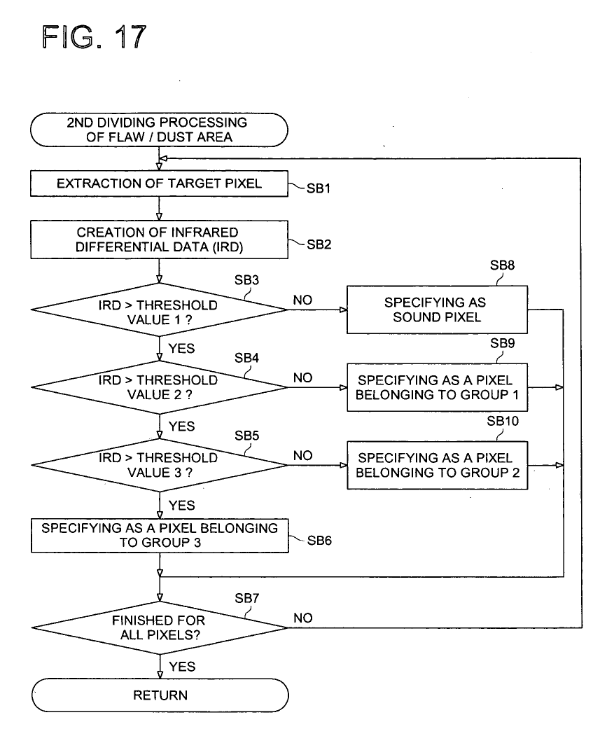

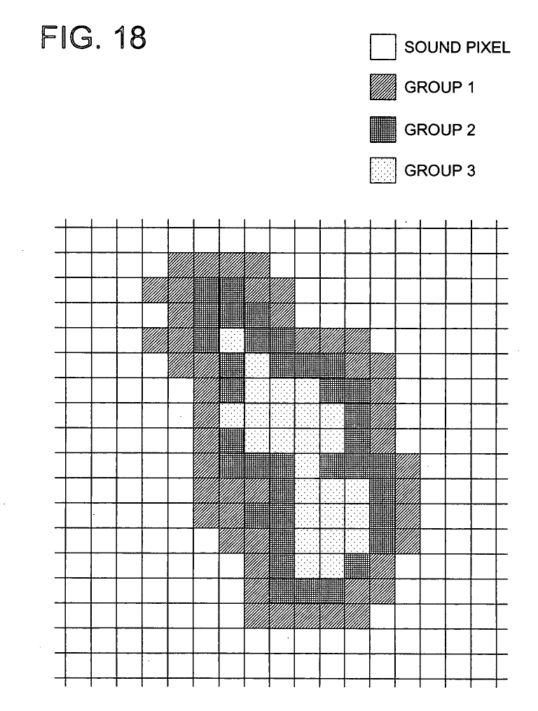

Subsequently, with reference to FIG. 15 to FIG. 18, a first and a second dividing processing of a flaw/dust area as two concrete examples of the dividing processing of a flaw/dust area in the step 351 of the third flaw/dust correction processing will be explained. FIG. 15 is a flow chart of the first dividing processing of a flaw/dust area. FIG. 16 is a drawing showing three partial areas in a flaw/dust area which has been divided by the first dividing processing of a flaw/dust area. FIG. 17 is a flow chart showing the second dividing processing of a flaw/dust area. FIG. 18 is a drawing showing three partial areas in a flaw/dust area which has been divided by the second dividing processing of a flaw/dust area.

First, with reference to FIG. 15 and FIG. 16, the first dividing processing of a flaw/dust area will be explained. The first dividing processing of a flaw/dust area is an example as a dividing method for grouping an area into partial areas on the basis of the distance from the periphery of the area. As shown in FIG. 15, first, one pixel is extracted as a target pixel from visible image information (step SA1). Then, it is judged whether or not the target pixel is located in a flaw/dust area (step SA2). If the target pixel is not located in a flaw/dust area (step SA2: NO), the procedure moves to the step SA6.

If the target pixel is located in a flaw/dust area (step SA2: YES), it is judged whether or not a sound pixel is present in the eight neighboring pixels adjacent to the target pixel (step SA3). If there is no sound pixel included in the 8 neighboring pixels (step SA3: NO), it is judged whether or not a sound pixel is present in the 5×5 pixels with the target pixel located at the center (step SA4). If no sound pixel is present in the 5×5 pixels (step SA4: NO), the target pixel is determined to be a pixel belonging to the group 3 as the partial area of the flaw/dust area (step SA5).

Then, it is judged whether or not all the pixels of the visible image information have been extracted as a target pixel each in the step SA1 (step SA6). If not all the pixels have been extracted (step SA6: NO), the procedure moves to the step SA1, where a pixel which has not been extracted is extracted as the next target pixel. If all the pixels have already been extracted (step SA6: YES), the first dividing processing of a flaw/dust area is finished. After the completion of the first dividing processing of a flaw/dust area, the procedure moves to the next step (the step S352 of FIG. 14).

If there is a sound pixel in the 8 neighboring pixels (step SA3: YES), the target pixel is determined to be a pixel belonging to the group 1 as a partial area of the flaw/dust area (step SA7), and the procedure moves to the step SA6. If there is a sound pixel within the range of 5×5 pixels (step SA4: YES), the target pixel is determined to be a pixel belonging to the group 2 as a partial area of the flaw/dust area (step SA8), and the procedure moves to the step SA6.

By the first dividing processing of a flaw/dust area, for example, as shown in FIG. 16, a flaw/dust area is divided into the group 1, the group 2, and the group 3 as the divisional areas. In addition, as regards the number of the groups, it may be suitably determined, and generally three or more is desirable. Further, the condition for a pixel to belong to any one of the groups is not limited to whether or not a sound pixel is included in its eight neighboring pixels and whether or not a sound pixel is included in the surrounding 5×5 pixels, but some other condition may be appropriate.

Next, with reference to FIG. 17 and FIG. 18, the second dividing processing of a flaw/dust area will be explained. The second dividing processing of a flaw/dust area is an example of recognition of a flaw/dust area based on the infrared image information, and an example of grouping pixels on the basis of threshold values of three (the number of the groups) levels provided for the discrimination of a flaw/dust area. In cases where the infrared image information has a sufficient accuracy of position, this is a method capable of being actually used simply.

A threshold value 1, a threshold value 2, and a threshold value 3 for determining the divisional areas are set beforehand. Further, it is assumed that the threshold value 1<the threshold value 2<the threshold value 3. As shown in FIG. 17, first, one pixel is extracted as a target pixel from the visible image information (step SB1). Then, by the use of the infrared image information, an infrared difference data (IRD) for the target pixel is created (step SB2). For example, in the same way as the steps S132 and S136, the infrared image data is created. In the following, in this embodiment, for the reasons of discussing relative magnitude relation to the threshold values, the sign of the infrared difference data is defined as positive; therefore, an infrared difference data, having been converted into an absolute value, is dealt with. In another way, also it is appropriate to put it into practice that the infrared difference data which were created in the steps S132 and S136 of FIG. 6 have been saved, and the saved infrared difference data are acquired in the step SB2. Then, it is judged whether or not the IRD of the target pixel created in the step SB2 is greater than the threshold value 1 (step SB3).

If the IRD of the target pixel is greater than the threshold value 1 (step SB3: YES), it is judged whether or not the IRD of the target pixel is greater than the threshold value 2 (step SB4). If the IRD of the target pixel is greater than the threshold value 2 (step SB4: YES), it is judged whether or not the IRD of the target pixel is greater than the threshold value 3 (step SB5). If the IRD of the target pixel is greater than the threshold value 3 (step SB5: YES), the target pixel is determined to be a pixel belonging to the group 3 as a partial area of the flaw/dust area (step SB6).

Then, it is judged whether or not all the pixels of the visible image information have been extracted as a target pixel each in the step SB1 (step SB7). If not all the pixels have been extracted (step SB7: NO), the procedure moves to the step SB1, where a pixel which has not been extracted is extracted as a target pixel. If all the pixels have already been extracted (step SB7: YES), the second dividing processing of a flaw/dust area is finished. After the completion of the second dividing processing of a flaw/dust area, the procedure moves to the next step (step S352 of FIG. 14).

If the IRD of the target pixel is not greater than the threshold value 1 (step SB3: NO), the target pixel is determined to be a sound pixel (step SB8), and the procedure moves to the step SB7. If the IRD of the target pixel is not greater than the threshold value 2 (step SB4: NO), the target pixel is determined to be a pixel belonging to the group 1 as a partial area of the flaw/dust area (step SB9), and the procedure moves to the step SB7. If the IRD of the target pixel is not greater than the threshold value 3 (step SB5: NO), the target pixel is determined to be a pixel belonging to the group 2 as a partial area of the flaw/dust area (step SB10), and the procedure moves to the step SB7.

By the second dividing processing of a flaw/dust area, for example, as shown in FIG. 18, a flaw/dust area is divided into the group 1, the group 2, and the group 3. In addition, the number of groups may be determined suitably, but generally, three or more is desirable.

In the third flaw/dust correction processing, the flaw/dust correction processing is practiced in all the areas which have been made partial areas; however, for example, because the most outer peripheral partial area (group 1) of FIG. 16, or in the partial area (group 1) of FIG. 18 which is subjected to the smallest influence of a flaw/dust has a high association with sound pixels outside the area, it does not matter if it is processed by an interpolation method based on the peripheral sound pixels.

Up to now, it has been explained a method in which, in order to cope with the non-uniformity of the structure existing in a flaw/dust area, a flaw/dust area is divided into a plurality of partial areas, and an individual calculation of the processing values are carried out for each of the partial areas.

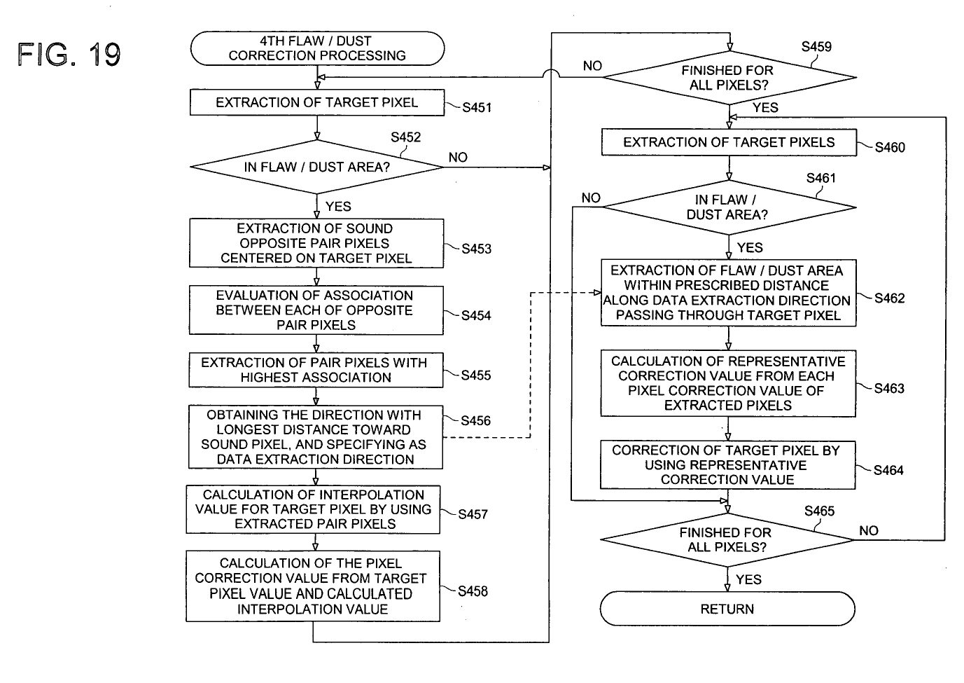

Next, with reference to FIG. 19, a fourth flaw/dust correction processing as one mode of practice of the flaw/dust correction processing of the step S15 in the flaw/dust processing shown in FIG. 4 will be explained. FIG. 19 is a flow chart showing the fourth flaw/dust correction processing. The fourth flaw/dust correction processing is one that actualizes it by another method to cope with the above-mentioned non-uniformity of the structure.

As shown in FIG. 19, first, steps S451 to S455 are practiced. The steps S451 to S455 is the same as the steps S251 to S255 in the second flaw/dust correction processing of FIG. 10. Then, a direction in which the distance from the target pixel to a sound pixel is longest is obtained, and this direction is determined to be a data extraction direction (step S456). This direction of the longest distance corresponds, in the example of FIG. 11, to the leftward-uprising oblique direction.

Then, steps S457 to S461 are practiced. The steps S457 to S461 are the same as the steps S256 to S260 in the second flaw/dust correction processing of FIG. 10. Then, the procedure moves to the right-side flow shown in the drawing. First, as regards the pixels in the flaw/dust area, pixels within a specified distance from the target pixel in the data extraction direction obtained by the calculation of the step S456 are extracted (step S462). The specified distance may be a distance set beforehand, for example, a distance of 4 pixels from the target pixel located at the center, or the specified range may be set corresponding to the distance between the pair of sound pixels in the above-mentioned data extraction direction.

Then, the steps S463 to S465 are practiced. The steps S463 to S465 are the same as the steps S262 to 264 in the second flaw/dust correction processing of FIG. 10. After the completion of the fourth flaw/dust correction processing, the procedure moves to the next step (the flaw/dust interpolation processing of the step S15 of FIG. 4 or the step S2 of FIG. 3).

The fourth flaw/dust correction processing has been found by the inventors having noticed that a flaw area and a dust area caused by many dust particles appear with a long and narrow form in many cases, and such a flaw area and a dust area tend to become most noticeable. For the reason that image defects giving a uniform influence to the image information is continuously exist along the lengthwise direction of a flaw/dust area, a high-accuracy processing result can be obtained by the calculation of a representative value using such a data extraction direction as described in the above.

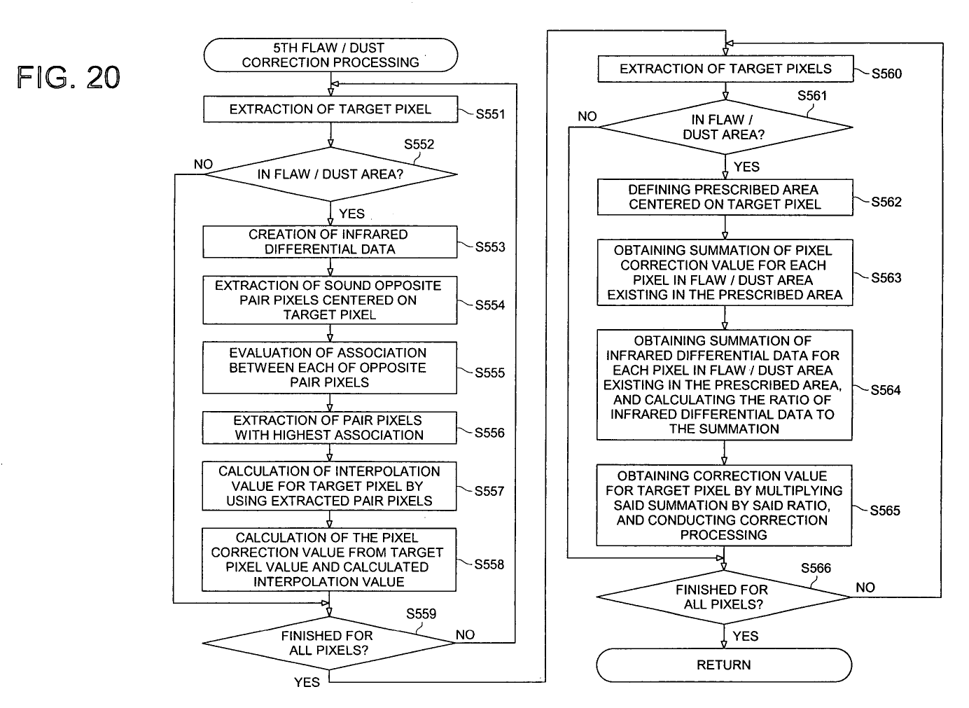

Next, with reference to FIG. 20, a fifth flaw/dust correction processing as one mode of practice of the flaw/dust correction processing of the step 15 in the flaw/dust processing of FIG. 4 will be explained. FIG. 20 is a flow chart showing the fifth flaw/dust correction processing. The fifth flaw/dust correction processing actualizes it by a further another method to cope with the above-mentioned non-uniformity of the structure. Further, in the fifth flaw/dust correction processing, infrared image information is used in the evaluation of a flaw/dust area.

As shown in FIG. 20, first, steps S551 and S552 are practiced. The steps S551 and S552 are the same as the steps S251 and S252 in the second flaw/dust correction processing of FIG. 10. Then, by the use of the infrared image information, the infrared difference data of the target pixel is created (step S553). The infrared difference data is created, for example, in the same manner as the steps S132 and S136. In another way, also it is appropriate to put it into practice that the infrared difference data which were created in the steps 132 and S136 of FIG. 6 have been saved, and the saved infrared difference data are acquired in the step S553.

Then, steps S554 to S561 are practiced. The steps S554 to S561 are the same as the steps S253 to 260 in the second flaw/dust correction processing of FIG. 10. Then, a specified area with the target pixel located at its center is defined (step S562). Then, the total sum correction value of the pixel correction values of the pixels existing in the specified area is calculated (step S563).

Then, the total sum of the infrared difference data of all the inside-flaw/dust-area pixels existing in the specified area is calculated, and the proportion of the infrared difference data of the target pixel to the total sum of the infrared difference data is calculated (step S564). Then, the total sum correction value calculated in the step S563 is multiplied by the proportion calculated in the step S564, the product is defined as the correction value of the target pixel, and by the use of the correction value of the target pixel, the target pixel value of the visible information is corrected (step S565).

Then, it is judged whether or not all the pixels of the visible image information have been extracted as a target pixel each in the step S560 (step S566). If not all the pixels have been extracted (step S566: NO), the procedure moves to the step S560, where a pixel which has not been extracted is extracted as the next target pixel. If all the pixels have already been extracted (step S566: YES), the fifth flaw/dust correction processing is finished. After the completion of the fifth flaw/dust correction processing, the procedure moves to the next step (the flaw/dust interpolation processing of the step S15 of FIG. 4 or the step S2 of FIG. 3).

By the fourth or the fifth flaw/dust correction processing, without dividing a flaw/dust area into a definite plural areas, in a case where a flaw/dust area has a structure inside, it is possible to extract simply the influence of the internal structure of the flaw/dust area to the image, and as regards the actual image correction values, a correction processing is practiced by the use of visible image signal values; therefore, it is unnecessary to take into consideration the MTF characteristics, flare characteristics, contrast characteristics, etc. of the infrared image information and the visible image information, and a certain and stabilized result of correction processing can be obtained.

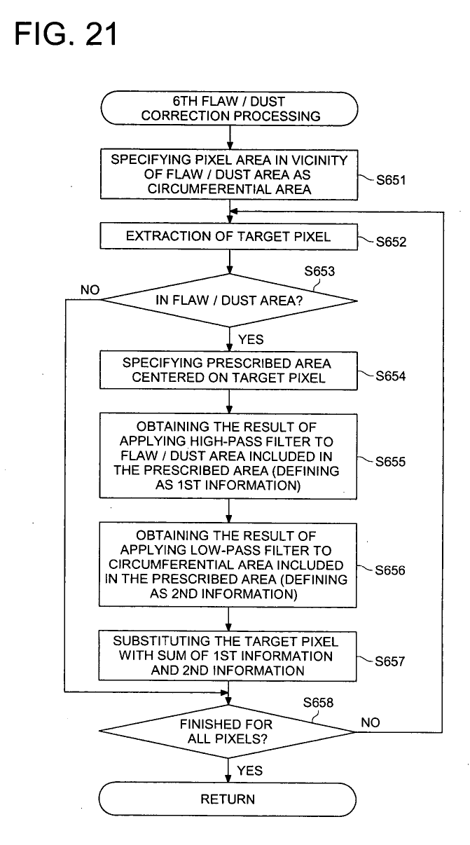

Next, with reference to FIG. 21, a sixth flaw/dust correction processing as one mode of practice of the flaw/dust correction processing of the step S15 in the flaw/dust processing of FIG. 4 will be explained. FIG. 21 is a flow chart showing the sixth flaw/dust correction processing. The sixth flaw/dust correction processing is an application example in which a correction processing for a flaw/dust area is carried out in a way of interpolation.

As regards a method of filling a defect area such as a flaw/dust area by an interpolation processing, various kinds of it are known. In any one of the methods, an interpolation method fills a defect area to be interpolated with surrounding data. For this reason, between the peripheral area and the defective area, for example, the graininess of image (a rough feeling of a silver halide photograph caused by graininess and a random noise) is different, which produces an unnatural correction result in many cases.

The sixth flaw/dust correction processing carries out the processing by utilizing the information which a defect area possesses as much as possible; therefore, an image processing result which hardly gives an unnatural impression can be obtained.

First, steps S651 to 653 are practiced. The steps S651 to S653 are the same as the steps S251 to S253 in the second flaw/dust correction processing of FIG. 10 respectively. If the target pixel is located in a flaw/dust area (step S653: YES), a specified range with the target pixel located at its center is defined (step S654). The specified range is, for example, a rectangular area in a simple case, but it is also appropriate to make it a circular area of a specified radius.

Then, a high-pass filter is applied to the flaw/dust area included in the specified range, and the processing result by means of the high-pass filter at the target pixel position is acquired as first information (step S656). This high-pass filter is, for example, a filter for applying a processing of subtracting the average value of the pixel signal values belonging to the flaw/dust area included in the specified range from the target pixel value. For another example, it is also possible to utilize a Laplacian filter or a filter of its variation.

Further, a low-pass filter is applied to the peripheral area included in the specified range, and the processing result by means of the low-pass filter at the position of the target pixel is acquired as the second information (step S656). For this low-pass filter, in a simple case, a filter for calculating the average value of the pixel values belonging to the peripheral area included in the specified range, or a spatial frequency band pass filter as described before may be used. Further, also it is appropriate that weighting factors are prepared in accordance with the distance from the target pixel, the total sum of the weighting factors corresponding to the peripheral area pixels included in the specified range is normalized to 1, and the second information is obtained as the sum of the products of inside-area image signal values and the normalized weighting factors. Then, the target pixel value is substituted by the signal value that is the sum of the first information and the second information (step S657).

Then, it is judged whether or not all the pixels in the visible image information have been extracted as a target pixel each in the step S652 (step S658). If not all the pixels have been extracted (step S658: NO), the procedure moves to the step S652, where a pixel which has not been extracted is extracted as the next target pixel. If all the pixels have already been extracted (step S658: YES), the sixth flaw/dust correction processing is finished. After the completion of the sixth flaw/dust correction processing, the procedure moves to the next step (the flaw/dust interpolation processing of the step S15 of FIG. 4 or the step S2 of FIG. 3).

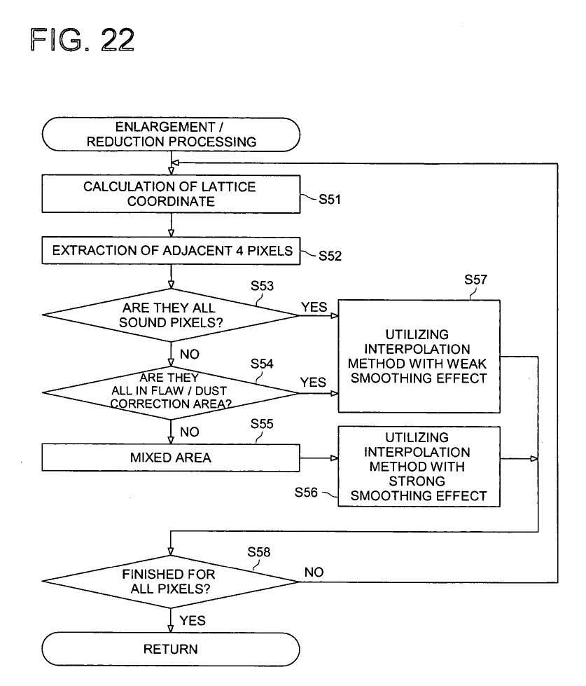

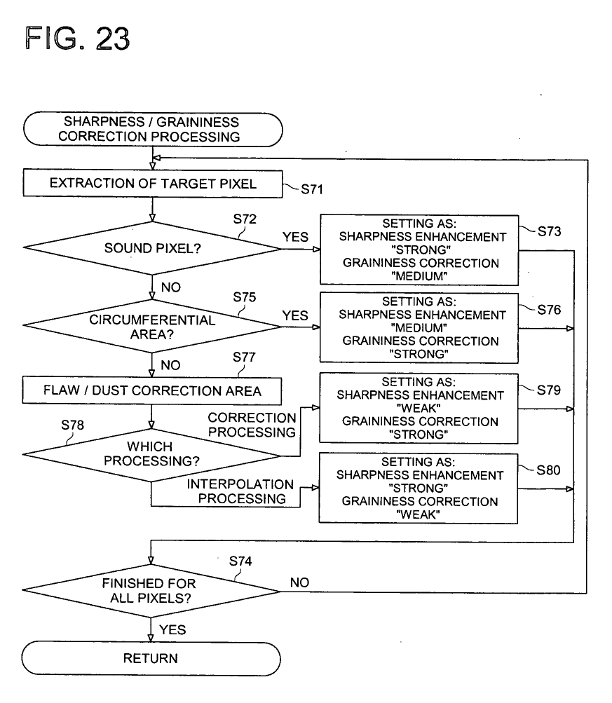

With reference to FIG. 22 and FIG. 23, an enlargement/reduction processing of the step S5 and the sharpness/graininess correction processing of the step S7 in the image processing of FIG. 3 will be explained. FIG. 22 is a flow chart showing the enlargement/reduction processing. FIG. 23 is a flow chart showing the sharpness/graininess correction processing.

First, with reference to FIG. 22, the enlargement/reduction processing will be explained. An enlargement/reduction processing gives different results depending on its technique, in particular, a great difference in the effect of smoothing image information. First, lattice point coordinates which are necessary for the enlargement/reduction in the visible image information are calculated (step S51). A lattice point is an intermediate point, for example, to be interpolated between the pixels to be enlarged. Then, four pixels surrounding the calculated lattice point concerned are extracted (step S52). The surrounding four pixels are used in the interpolation calculation of the lattice point. Then, it is judged whether or not the surrounding four pixels are sound pixels only (step S53).

If the surrounding four pixels are not sound pixels only (step S53: NO), it is judged whether or not the surrounding pixels are located in a flaw/dust area only (step S54). If the surrounding four pixels are not located in a flaw/dust area only (step S54: NO), the surrounding four pixels are regarded as located in a mix area as an area in which sound pixels and a flaw/dust area exist mixedly (step S55). Then, it is possible to regard the difference of the signal value between the pixels in the mix area as large; therefore, by the utilization of an interpolation method of a strong smoothing ability, an enlargement/reduction processing is applied to the target pixel (step S56). By an interpolation method of a strong smoothing ability, an image processing result which makes the boundary of the flaw/dust processing which is hardly noticeable can be obtained.

If the four surrounding pixels are sound pixels only (step S53: YES), or if the four surrounding pixels are located in a flaw/dust area only (step S54: YES), it is possible to recognize that all of the four surrounding pixels are included in either a sound pixel area or a flaw/dust area, and the difference of the signal value between the pixels in the area can be regarded as small; therefore, by the utilization of an interpolation method of a weak smoothing ability, an enlargement/reduction processing is applied to the target pixel (step S57).

Then, it is judged whether or not all the lattice points over the whole frame of the visible image information necessary for the enlargement/reduction have been extracted (calculated) in the step S51 (step S58). If all the lattice points have been extracted (step S58: YES), the enlargement/reduction processing is finished. If not all the lattice points have been extracted (step S58: NO), the procedure moves to the step S51, where a lattice point which has not been extracted is calculated as the next lattice point. After the completion of the enlargement/reduction processing, the procedure moves to the next step (step S6 of FIG. 3).

As regards the interpolation method in the enlargement/reduction processing, for example, interpolation methods described in the publication of the unexamined patent application 2002-262094 can be used. Among the methods, to an enlargement/reduction of a magnification ratio for a small amount of size change which tends to produce a moire due to the size change, etc., a linear interpolation method using pixel data of nine neighboring points having a large smoothing effect is applied, and to others, an interpolation method using pixel data of four neighboring points having a comparatively small smoothing effect is applied. That is, in this embodiment, a desirable effect can be obtained by it that the former is applied to a mix area portion of a flaw/dust correction area and a sound pixel area (corresponding to the step S56), and the latter is applied to other areas (corresponding to the step S57).

Next, with reference to FIG. 23, a sharpness/graininess correction processing will be explained. First, one pixel in the visible image information is extracted as a target pixel (step S71). Then, it is judged whether or not the target pixel is a sound pixel (step S72). If the target pixel is a sound pixel (step S72: YES), the enhancement of sharpness is set as “strong”, the graininess correction is set as “medium”, and on the basis of the setting value, a sharpness enhancement/graininess correction processing is carried out (step S73).

Then, it is judged whether or not all the pixels of the visible image information have been extracted as a target pixel each in the step S71 (step S74). If all the pixels have already been extracted (step S74: YES), the sharpness/graininess correction processing is finished. If not all the pixels have been extracted (step S74: NO), the procedure moves to the step S71, where a pixel which has not been extracted yet is extracted as the next target pixel. After the completion of the sharpness/graininess correction processing, the procedure moves to the next step (the step S8 of FIG. 3).

If the target pixel is not a sound pixel (step S72: NO), it is judged whether or not the target pixel is located in the peripheral area (step S75). The peripheral area is an area existing at the border between the flaw/dust-processed area and the non-flaw/dust-processed area. If the target pixel is located in the peripheral area (step S75: YES), the sharpness enhancement is set as “medium”, and the graininess correction is set as “strong”, and on the basis of the set values, the sharpness enhancement and the graininess correction are applied to the target pixel (step S76); then, the procedure moves to the step S74. Because there is a possible problem that the boundary line becomes noticeable if the sharpness enhancement is made strong, some amount of modification is made. In addition to it, the graininess correction is made somewhat stronger (graininess is suppressed).

If the target pixel is not located in the peripheral area (step S75: NO), the target pixel is regarded as located in the flaw/dust area (step S77). In the case where the target pixel is located in the flaw/dust area, by making a correction different from that for a sound pixel, one can obtain a processing result which is totally made uniform and has a trace of the flaw/dust processing that is hardly noticeable. As regards a flaw/dust area, it is desirable to discriminate one from another on the basis of the method of processing which has been applied to it. Therefore, it is judged whether a flaw/dust correction processing or a flaw/dust interpolation processing has been applied to the target pixel (step S78). If a flaw/dust correction processing has been practiced (step S78: correction processing), the sharpness enhancement is set as “weak”, and the graininess processing is set as “strong”, and on the basis of the set values, the sharpness enhancement processing and the graininess correction are applied to the target pixel (step S79); then, the procedure moves to the step S74. For example, in the case where a flaw/dust correction processing has been practiced, because it strengthens and restores an attenuated signal, for the purpose of suppressing the noise, the graininess correction for the area concerned is made stronger than usual (graininess suppression is applied strongly). In addition to it, the degree of sharpness enhancement is made weak.

If a flaw/dust interpolation processing has been practiced (step S78: interpolation processing), the sharpness enhancement is set as “strong”, and the graininess correction is set as “weak”, and on the basis of the set values, the sharpness enhancement and the graininess correction are applied to the target pixel (step S80); then, the procedure moves to the step S74. At the places where a flaw/dust interpolation processing has been applied, in most cases, noise component is reduced because of the steps of weighted averaging being included in the processing. For this reason, the graininess correction is applied weakly, and relatively the sharpness enhancement is applied strongly.

The relation between the sharpness enhancement and the graininess correction described up to now is an explanation in the case where a flaw/dust correction processing and a flaw/dust interpolation processing as an example each is assumed, and it is not to be limited to this, whether each of the correction processing and the interpolation processing is made strong or weak, but by the switching-over of the method of the flaw/dust correction and/or interpolation processing, it is to be adjusted suitably.

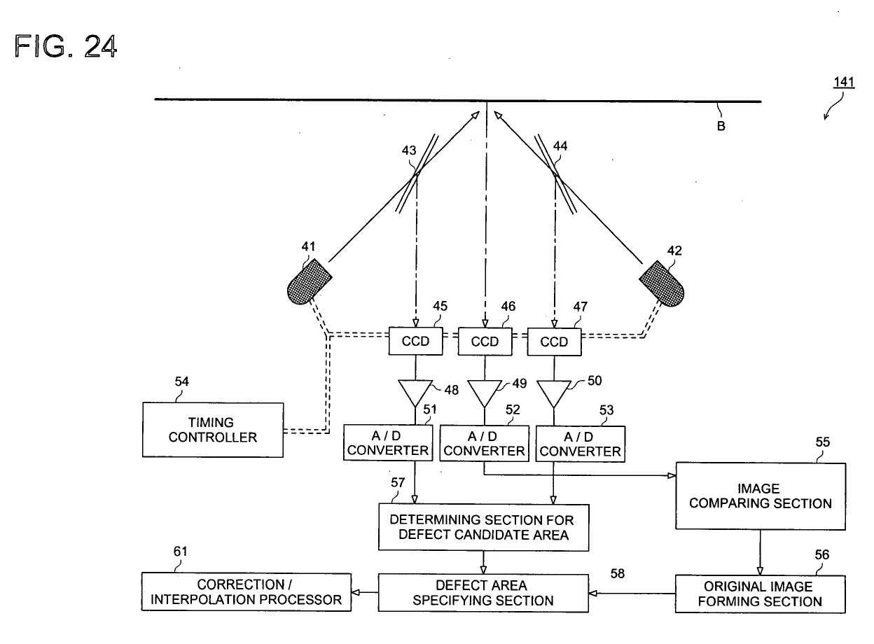

Next, a case where the image acquisition in the image acquisition section 14 is carried out by the reflection original scanner 141 instead of the transmission original scanner 142 will be explained. Among the examples of the embodiment of this invention, the first flaw/dust correction processing of FIG. 8, the second flaw/dust correction processing of FIG. 10, the third flaw/dust correction processing of FIG. 14 (in the case where an infrared difference data is not used for the dividing of a flaw/dust area), the fourth flaw/dust correction processing of FIG. 19, and the sixth flaw/dust correction processing of FIG. 20 do not need infrared image information for the image correction; therefore, it is enough if a flaw/dust candidate area can be obtained by some method. Then, with reference to FIG. 24, as a structure in which infrared image information is not acquired, the reflection original scanner 141 of the image acquisition section 14 of FIG. 1 will be explained. FIG. 24 is a drawing showing the internal structure of the reflection original scanner 141.

As shown in FIG. 24, the reflection original scanner 141 is equipped with light sources 41 and 42 for a photographic original (such as a glossy photographic paper) B, half mirrors 43 and 44 for transmitting and reflecting the light emitted from the light sources 41 and 42 respectively, CCD sensors 45 to 47 for receiving the light forming an image thereon, amplifiers 48 to 50 for amplifying the analog signals outputted from the CCD sensors 45 to 47 respectively, and A/D converters 51 to 53 for converting the analog signals outputted from the amplifiers 48 to 50 into digital signals respectively.

Further, the reflection original scanner 141 is equipped with a timing controller 54 for controlling the timings of the light emission of the light sources 41 and 42 and the light receiving of the CCD sensors 45 to 47, an image comparing section 55 for comparing the two kinds of image information corresponding to the light beams emitted from the light sources 41 and 42, an original image forming section 56 for forming original image information from the result of comparison outputted from the image comparing section 55, a defect candidate determining section 57 for determining a defect candidate area on the basis of the two kinds of image information outputted from the A/D converters 51 and 53, and a defect area specifying section 58 for specifying a defect area on the basis of the defect candidate area outputted from the defect candidate area determining section 57, and outputting the defect area together with the original image information outputted from the original image forming section 56.

Further, the defect area and the original image information outputted from the defect area specifying section 58 are transmitted to a correction/interpolation processor 61 in the image processor 11. The photographic original B may be any one so long as it has a uniform gloss.

Next, the operation of the reflection original scanner 141 will be explained simply. First, a photographic original B is irradiated by the two light sources 41 and 42. The light sources 41 and 42 are made to emit light alternately by the timing controller 54. The CCD sensor 46 picks up the image irradiated by both the light sources. The CCD sensor 47 picks up the image irradiated by the light transmitted by the half mirror 43 and reflected by the half mirror 44 at the timing the light source 41 is turned on. The CCD sensor 45 picks up the image irradiated by the light transmitted by the half mirror 44 and reflected by the half mirror 43 at the timing the light source 42 is turned on.

As regards the image information picked up by the CCD sensor 46, its brightness is compared between the light sources, and in a case where there is a brightness difference, the darker one is regarded as important; the image information of its one frame is formed as original image information. By such a procedure, it is possible to remove the reflection due to microscopic unevenness of a glossy photographic paper (photographic original B) and the glossy reflection of a silk-finish photographic paper (photographic original B), which makes it possible to obtain desirable original image information.

On the other hand, as regards the image information picked up by the CCD sensors 45 and 47, in the defect image candidate area determining section 57, in a case where an image area of data not falling within a range of a specified image signal value is picked up by each of the CCD sensors 45 and 47 and both the output image areas agree to each other, the image area is defined as a defect candidate area due to dust or the like. The defect candidate area is subjected to a noise processing by the defect area specifying section 58, and is subjected to size enlargement through an opening processing, to be made a defect area.

The correction/interpolation processor 61 receives the original image information and the information of defect area, and on the basis of these bits of information, a flaw/dust correction processing or a flaw/dust interpolation processing is practiced.

As explained above, according to the second flaw/dust correction processing of this embodiment, visible image information is corrected through the procedure that a representative correction value as a modified correction value is calculated on the basis of a pixel correction value as a provisional correction value for each of the defective pixels in a flaw/dust area and for each of the defective pixels in its neighborhood, and by the use of the representative correction value, each of the defective pixel values are corrected. Owing to this, for example, even in a defective condition such that an image loss caused by a damage in the image recording layer of an image information acquisition source is produced, which makes the correction of signal strength based on the infrared image information a reverse correction, or in a state that a residual aberration of an amount not to be neglected remains in the infrared image information, a satisfactory result of image processing can be obtained, because data of defective pixels are corrected on the basis of the visible image information. Further, a high-accuracy removal of the influence of flaw/dust can be actualized by a correction of image information through a procedure that a pixel correction value is obtained for each pixel of the image information in the defective place, and the error portion of the pixel correction value is removed as a noise by the representative correction value. Further, in a case where the procedure from the selection of a pair of pixels opposite to each other to the calculation of pixel correction value is carried out for each of the image information components R, G, and B, and the correction is carried out through the calculation of the representative correction value based on the characteristics of the color components, the information volume to be used in the calculation of the correction values is increased, which makes it possible to actualize a removal of the influence of flaw/dust with a higher removal effect of the noise component in the image information.

Further, according to the first flaw/dust correction processing, a correction value of the visible image information is calculated on the basis of the characteristic values of the defect area and the peripheral area of the visible image information itself, and the image information is corrected by the use of the correction value. Owing to this, for example, it is possible to effectively cope with a defective condition caused by a damage on a film by the practice of a correction using not the infrared image information but the visible image information. Further, by the correction using the correction value calculated from the characteristic values of a flaw/dust area and its peripheral area, even if the color aberration and the flare characteristic of the optical system by which the image information is acquired are unknown, a correction result that is neither excessive nor insufficient can be obtained.

Further, according to the sixth flaw/dust correction processing, the third information as the correction value is calculated through the addition of the first information obtained by the high-pass filter processing of a flaw/dust area of the visible image information and the second information obtained by the low-pass filter processing of the peripheral area, and the visible image information is corrected by the use of the third information. Owing to this, by the correction of a defect area caused by a loss (damage) of the image recording layer of an image information acquisition source (film), even if the color aberration and the flare characteristic of the optical system by which the image information is acquired are unknown, a correction result that is neither excessive nor insufficient can be obtained.

Further, according to the third flaw/dust correction processing, visible image information is corrected through the procedure that a flaw/dust area is divided into a plurality of partial areas, a representative correction value as a modified pixel correction value is calculated on the basis of pixel correction values as provisional correction values of the defective pixels in the flaw/dust area and the neighboring defective pixels belonging to the same partial area, and the defective pixel value is corrected by the use of the representative correction value. Owing to this, in the case where infrared image information is not used for the dividing of a flaw/dust area into its partial areas, it is possible to effectively cope, for example, even with a defective condition caused by a loss (damage) of the image recording layer on the image information acquisition source (film), by the practice of a correction using not the infrared image information but the visible image information. Further, even in a state that the influence of a residual aberration of an amount not to be neglected remains in the infrared image information, a satisfactory result of image processing can be obtained, because defective pixel values are corrected on the basis of the visible image information. Further, because a flaw/dust area is divided into a plurality of partial areas in accordance with the feature quantity (the positional relation to a sound pixel or the infrared difference data) of the defective pixels located inside, and the correction is carried out on the basis of each of the partial areas, a desirable correction result of a higher degree of freedom can be obtained.

In addition, the above mentioned description of this embodiment is an example of a suitable image processing system 10 of this invention, and it is not to be limited to this.

(Effect of the Invention)

According to the invention set forth in (1), a modified pixel correction value is calculated on the basis of a provisional correction value of each of defective pixels and that of each of its neighboring defective pixels in the image information, and data of each of the defective pixels are corrected by the use of the modified pixel correction value. Owing to this, for example, even in a defective condition such that an image loss caused by a damage in the image recording layer of an image information acquisition source is produced, which makes the correction of signal strength based on the image information of the infrared region a reverse correction, or in a state that an influence of a residual aberration of an amount not to be neglected remains in the image information of the infrared region, a satisfactory result of image processing can be obtained, because data of defective pixels are corrected on the basis of the image information of the visible regions. Further, a high-accuracy removal of the influence of defects can be actualized by a correction of image information through a procedure that a provisional correction value is obtained for each of the defective pixels, and the error portion of the provisional correction value is removed as a noise by the modified pixel correction value.

According to the invention set forth in (2), because the correction value is obtained by the use of data of plural color images, information volume to be used in calculating the correction value is increased, and a removal of the influence of defects with a high effect of removal of the noise component of the image information can be actualized.

According to the invention set forth in (3), the correction value is calculated from the characteristic value of a defective area and that of its peripheral area of the image information itself, and the image information of the visible region is corrected by the use of the correction value. Owing to this, for example, even for a defective condition such that an image loss caused by a damage in the image recording layer of an image information acquisition source is produced, which makes the correction of signal strength based on the image information of the infrared region a reverse correction, it is possible to effectively cope with the defective condition by a correction using the image information not of the infrared region but of the visible region. Further, by the correction using the correction value calculated from the characteristic value of a defective area and that of its peripheral area, even if the characteristics such as the color aberration and the flare characteristic of the optical system used in the acquisition of the image information are unknown, a correction result which is neither excessive nor insufficient can be obtained.

According to the invention set forth in (4), the third information as the correction value is calculated through the addition of the first information based on a defective area and the second information based on its peripheral area of the image information itself, and the image information is corrected by the use of the third information. Owing to this, by the correction of a defective area caused by a damage of the image recording layer of an image information acquisition source, even if the characteristics such as the color aberration and the flare characteristic of the optical system used in the acquisition of the image information are unknown, a correction result which is neither excessive nor insufficient can be obtained.

According to the invention set forth in (5), defective pixels are divided into a plurality of groups, a modified pixel correction value is calculated on the basis of a provisional correction value of each of said defective pixels and that of each of its neighboring defective pixels belonging to the same group, and data of each of the defective pixels are corrected by the use of the modified pixel correction value. Owing to this, because defective pixels caused by a loss of the image recording layer of an image information acquisition source are divided into a plurality of groups on the basis of their feature quantities, and their data are corrected on the basis of their respective groups, a desirable correction result of a higher degree of freedom can be obtained. Further, even in a state that residual aberrations of an amount not to be neglected remain in the image information of the infrared region, a satisfactory image processing result can be obtained, because data of defective pixels are corrected on the basis of the image information of the visible region.

What is claimed is:

1. An image processing method for correcting data of defective pixels in image information, comprising the steps of:
dividing the image information into data of sound pixels and data of defective pixels;
calculating an interpolation signal value of each of the defective pixels on the basis of data of a plurality of sound pixels existing in the surrounding area of each of the defective pixels in the image information;
calculating a provisional correction value for correcting data of each of the defective pixels on the basis of the signal value and the interpolation signal value of each of the defective pixels; and
calculating a modified pixel correction value of each of the defective pixels on the basis of the provisional correction value of each of the defective pixels and the provisional correction value of neighboring defective pixels existing in the neighborhood of each of the defective pixels; and
correcting the data of each of the defective pixels by the use of the modified pixel correction value.

2. The image processing method of claim 1, wherein the image information is composed of information concerning at least three kinds of plural color components; and in the step of calculating the modified pixel correction value, each of the provisional correction values is calculated for each of the plural color components, and each of modified pixel correction values for each of the plural color components is calculated from each of the provisional correction values for each of the plural color components.

3. An image processing method for correcting data of defective pixels in image information, comprising the steps of:
sorting the image information into data of a sound area and data of a defective area;
defining a group of sound pixels existing within a first specified distance from the boundary of the defective area as a peripheral area;
calculating respective characteristic values of the defective area and the peripheral area existing within a second specified distance from each of the defective pixels;
calculating a correction value to be used in the correction of the image data of each of the defective pixels on the basis of the characteristic values; and
correcting image data of the defective area through the correction of each of all the defective pixels by the use of the correction value concerned.

4. An image processing method for correcting data of defective pixels in image information, comprising the steps of:
sorting the image information into data of a sound area and data of a defective area;
defining a group of sound pixels existing within a first specified distance from the boundary of the defective area as a peripheral area;
calculating first information by applying a specified high-pass filter to the image data of pixels in the defective area located within a second specified distance from each of the defective pixels;
calculating second information by applying a specified low-pass filter to the image data of pixels in the peripheral area located within a third specified distance from each of the defective pixels;
calculating third information by an addition operation of the first information and the second information; and
correcting the image data of the defective area by substituting the image data of each of the defective pixels with the third information.

5. An image processing method for correcting data of defective pixels in image information, comprising the steps of:
dividing image data of defective pixels into a plurality of groups on the basis of their respective feature quantities;
calculating provisional correction values for correcting the image data of each of the defective pixels in the image information;
calculating a modified pixel correction value for each of the defective pixels, on the basis of each of the provisional correction values of each of the defective pixels and the provisional correction values of neighboring defective pixels which belong to the same group as each of the defective pixels and exist in the neighborhood of each of the defective pixels; and
correcting the image data of each of the defective pixels by the use of the modified pixel correction value.

6. An image processing method for correcting data of defective pixels in image information, comprising the steps of:
sorting image information including visible image information and infrared image information into image data of a sound area and image data of a defective area;
calculating, for each of the defective pixels within a specified distance from a target defective pixel to become the object of correction, a first pixel correction value on the basis of visible image information of pixels existing in the sound area, and obtaining a total sum of the first pixel correction value;
calculating, for each of the defective pixels within the specified distance, an infrared difference data is calculated on the basis of the infrared image information, and obtaining a total sum of the infrared difference data;
calculating a proportion of the infrared difference data corresponding to the target defective pixel to the total sum of the infrared difference data; and
correcting the image data of the target defective pixel, on the basis of the total sum of the first pixel correction values and the proportion.

7. An image processing apparatus for correcting data of defective pixels in image information, comprising:
an image acquiring section for acquiring an image information; and
a image processor for processing the image information, wherein the image processor is configured to:
divide the image information into data of sound pixels and data of defective pixels;
calculate an interpolation signal value of each of the defective pixels on the basis of data of a plurality of sound pixels existing in the surrounding area of each of the defective pixels in the image information;
calculate a provisional correction value for correcting data of each of the defective pixels on the basis of the signal value and the interpolation signal value of each of the defective pixels; and
calculate a modified pixel correction value of each of the defective pixels on the basis of the provisional correction value of each of the defective pixels and the provisional correction value of neighboring defective pixels existing in the neighborhood of each of the defective pixels; and
correct the data of each of the defective pixels by the use of the modified pixel correction value.

8. The image processing apparatus of claim 7, wherein the image information is composed of information concerning at least three kinds of plural color components; and when the image processor calculates the modified pixel correction value, each of the provisional correction values is calculated for each of the plural color components, and each of modified pixel correction values for each of the plural color components is calculated from each of the provisional correction values for each of the plural color components.

9. An image processing apparatus for correcting data of defective pixels in image information, comprising:
an image acquiring section for acquiring an image information; and
a image processor for processing the image information, wherein the image processor is configured to:
sort the image information into data of a sound area and data of a defective area;
define a group of sound pixels existing within a first specified distance from the boundary of the defective area as a peripheral area;
calculate respective characteristic values of the defective area and the peripheral area existing within a second specified distance from each of the defective pixels;
calculate a correction value to be used in the correction of the image data of each of the defective pixels on the basis of the characteristic values; and
correct image data of the defective area through the correction of each of all the defective pixels by the use of the correction value concerned.

10. An image processing apparatus for correcting data of defective pixels in image information, comprising:
an image acquiring section for acquiring an image information; and
a image processor for processing the image information, wherein the image processor is configured to:
sorting the image information into data of a sound area and data of a defective area;
define a group of sound pixels existing within a first specified distance from the boundary of the defective area as a peripheral area;
calculate first information by applying a specified high-pass filter to the image data of pixels in the defective area located within a second specified distance from each of the defective pixels;
calculate second information by applying a specified low-pass filter to the image data of pixels in the peripheral area located within a third specified distance from each of the defective pixels;
calculate third information by an addition operation of the first information and the second information; and
correcte the image data of the defective area by substituting the image data of each of the defective pixels with the third information.

11. An image processing apparatus for correcting data of defective pixels in image information, comprising:
an image acquiring section for acquiring an image information; and
a image processor for processing the image information, wherein the image processor is configured to:
divide image data of defective pixels into a plurality of groups on the basis of their respective feature quantities;
calculate provisional correction values for correcting the image data of each of the defective pixels in the image information;
calculate a modified pixel correction value for each of the defective pixels, on the basis of each of the provisional correction values of each of the defective pixels and the provisional correction values of neighboring defective pixels which belong to the same group as each of the defective pixels and exist in the neighborhood of each of the defective pixels; and
correcte the image data of each of the defective pixels by the use of the modified pixel correction value.

12. An image processing apparatus for correcting data of defective pixels in image information, comprising:
an image acquiring section for acquiring an image information; and
a image processor for processing the image information, wherein the image processor is configured to:
sorte image information including visible image information and infrared image information into image data of a sound area and image data of a defective area;
calculate, for each of the defective pixels within a specified distance from a target defective pixel to become the object of correction, a first pixel correction value on the basis of visible image information of pixels existing in the sound area, and obtaining a total sum of the first pixel correction value;
calculate, for each of the defective pixels within the specified distance, an infrared difference data is calculated on the basis of the infrared image information, and obtaining a total sum of the infrared difference data;
calculate a proportion of the infrared difference data corresponding to the target defective pixel to the total sum of the infrared difference data; and
correct the image data of the target defective pixel, on the basis of the total sum of the first pixel correction values and the proportion.

13. An image processing program for making a computer actualize an image processing function to correct data of defective pixels in image information, the image processing function comprising the functions of:
dividing the image information into data of sound pixels and data of defective pixels;
calculating an interpolation signal value of each of the defective pixels on the basis of data of a plurality of sound pixels existing in the surrounding area of each of the defective pixels in the image information;
calculating a provisional correction value for correcting data of each of the defective pixels on the basis of the signal value and the interpolation signal value of each of the defective pixels; and
calculating a modified pixel correction value of each of the defective pixels on the basis of the provisional correction value of each of the defective pixels and the provisional correction value of neighboring defective pixels existing in the neighborhood of each of the defective pixels; and
correcting the data of each of the defective pixels by the use of the modified pixel correction value.

14. The image processing program of claim 13, wherein the image information is composed of information concerning at least three kinds of plural color components; and in the function of calculating the modified pixel correction value, each of the provisional correction values is calculated for each of the plural color components, and each of modified pixel correction values for each of the plural color components is calculated from each of the provisional correction values for each of the plural color components.

15. An image processing program for making a computer actualize an image processing function to correct data of defective pixels in image information, the image processing function comprising the functions of:
sorting the image information into data of a sound area and data of a defective area;
defining a group of sound pixels existing within a first specified distance from the boundary of the defective area as a peripheral area;
calculating respective characteristic values of the defective area and the peripheral area existing within a second specified distance from each of the defective pixels;
calculating a correction value to be used in the correction of the image data of each of the defective pixels on the basis of the characteristic values; and
correcting image data of the defective area through the correction of each of all the defective pixels by the use of the correction value concerned.

16. An image processing method for correcting data of defective pixels in image information, comprising the steps of:
sorting the image information into data of a sound area and data of a defective area;
defining a group of sound pixels existing within a first specified distance from the boundary of the defective area as a peripheral area;
calculating first information by applying a specified high-pass filter to the image data of pixels in the defective area located within a second specified distance from each of the defective pixels;
calculating second information by applying a specified low-pass filter to the image data of pixels in the peripheral area located within a third specified distance from each of the defective pixels;
calculating third information by an addition operation of the first information and the second information; and
correcting the image data of the defective area by substituting the image data of each of the defective pixels with the third information.

17. An image processing program for making a computer actualize an image processing function to correct data of defective pixels in image information, the image processing function comprising the functions of:
dividing image data of defective pixels into a plurality of groups on the basis of their respective feature quantities;
calculating provisional correction values for correcting the image data of each of the defective pixels in the image information;
calculating a modified pixel correction value for each of the defective pixels, on the basis of each of the provisional correction values of each of the defective pixels and the provisional correction values of neighboring defective pixels which belong to the same group as each of the defective pixels and exist in the neighborhood of each of the defective pixels; and
correcting the image data of each of the defective pixels by the use of the modified pixel correction value.

18. An image processing program for making a computer actualize an image processing function to correct data of defective pixels in image information, the image processing function comprising the functions of:
sorting image information including visible image information and infrared image information into image data of a sound area and image data of a defective area;
calculating, for each of the defective pixels within a specified distance from a target defective pixel to become the object of correction, a first pixel correction value on the basis of visible image information of pixels existing in the sound area, and obtaining a total sum of the first pixel correction value;
calculating, for each of the defective pixels within the specified distance, an infrared difference data is calculated on the basis of the infrared image information, and obtaining a total sum of the infrared difference data;
calculating a proportion of the infrared difference data corresponding to the target defective pixel to the total sum of the infrared difference data; and
correcting the image data of the target defective pixel, on the basis of the total sum of the first pixel correction values and the proportion.
